(19) United States
(12) Patent Application Publication
(10) Pub. No.: US 2025/0301448 A1
(43) Pub. Date: Sep. 25, 2025

(54) ENVIRONMENT-BASED POSITIONING AND COMMUNICATION

(71) Applicant: QUALCOMM Incorporated, San Diego, CA (US)

(72) Inventors: Avinash SHRIVASTAVA, Hyderabad (IN); Stephen William EDGE, Escondido, CA (US)

(21) Appl. No.: 18/611,403

(22) Filed: Mar. 20, 2024

(51) Int. Cl. H04W 64/00; H04B 7/06

(52) U.S. Cl. CPC H04W 64/006; H04B 7/0617; H04B 7/0695

(57) ABSTRACT

Techniques for environment-based positioning and communication are disclosed. In some aspects, techniques include performing one or more positioning operations with respect to a user device in a wireless communication network, which may include obtaining first environmental information using one or more sensors of a wireless-enabled device; sending the first environmental information to a network entity of the wireless communication network; receiving first enhanced assistance data from the network entity, the first enhanced assistance data generated based at least on the first environmental information sent to the network entity; and performing the one or more positioning operations using the first enhanced assistance data received from the network entity, wherein the wireless-enabled device comprises the user device or a base station. In some aspects, techniques include improving communication in the wireless communication network, which may include receiving enhanced beamforming information from a network entity; and performing wireless communication using enhanced beamforming information.

### BACKGROUND

### 1. Field of Disclosure

The present disclosure relates generally to the field of wireless communications, and more specifically to, determining the location of a User Equipment (UE) using radio frequency (RF) signals and/or performing wireless communication between UE and a network device.

### 2. Description of Related Art

Sensors deployed within a wireless communications network (e.g., a cellular network such as a 5G network) can obtain environmental information and impart awareness of the environment to devices associated with the network. Examples of such sensors include radio frequency (RF) or radar sensors, antennas for positioning and determining location, inertial measurement units (IMUs, e.g., accelerometers, gyroscopes), cameras, infrared sensors, light (e.g., lidar) sensors, six-degrees-of-freedom (6DOF) sensors. UEs and other network devices such as a base station or access point may use one or more of such sensors to obtain information pertaining to its surroundings.

### BRIEF SUMMARY

In some aspects of the present disclosure, a method of performing one or more positioning operations with respect to a user device in a wireless communication network is disclosed. In some embodiments, the method may include: obtaining first environmental information using one or more sensors of a wireless-enabled device; sending the first environmental information to a network entity of the wireless communication network; receiving first enhanced assistance data from the network entity, the first enhanced assistance data generated based at least on the first environmental information sent to the network entity; and performing the one or more positioning operations using the first enhanced assistance data received from the network entity, wherein the wireless-enabled device comprises the user device or a base station.

In some aspects of the present disclosure, a user device is disclosed. In some embodiments, the user device may include: one or more transceivers configured to perform data communication in a wireless communication network; one or more memory; one or more processors communicatively coupled to the one or more transceivers and the one or more memory, the one or more processors configured to: obtain first environmental information using one or more sensors of a wireless-enabled device; send the first environmental information to a network entity of the wireless communication network; receive first enhanced assistance data from the network entity, the first enhanced assistance data generated based at least on the first environmental information sent to the network entity; and perform one or more positioning operations using the first enhanced assistance data received from the network entity, wherein the wireless-enabled device comprises the user device or a base station.

In some embodiments, the user device may include: means for obtaining first environmental information using one or more sensors of a wireless-enabled device; means for sending the first environmental information to a network entity of the wireless communication network; means for receiving first enhanced assistance data from the network entity, the first enhanced assistance data generated based at least on the first environmental information sent to the network entity; and means for performing one or more positioning operations using the first enhanced assistance data received from the network entity, wherein the wireless-enabled device comprises the user device or a base station.

In some aspects of the present disclosure, a non-transitory computer-readable medium is disclosed. In some embodiments, the non-transitory computer-readable medium includes a storage medium having instructions stored thereon, the instructions configured to, when executed by one or more processors, cause a user device in a wireless communication network to: obtain first environmental information using one or more sensors of a wireless-enabled device; send the first environmental information to a network entity of the wireless communication network; receive first enhanced assistance data from the network entity, the first enhanced assistance data generated based at least on the first environmental information sent to the network entity; and perform one or more positioning operations using the first enhanced assistance data received from the network entity, wherein the wireless-enabled device comprises the user device or a base station.

In some aspects of the present disclosure, another method of performing one or more positioning operations with respect to a user device in a wireless communication network is disclosed. In some embodiments, the method may include: receiving, at a network entity, first environmental information obtained by a wireless-enabled device of the wireless communication network; based at least on the first environmental information, generating first enhanced assistance data, the first enhanced assistance data comprising reference information having at least an accuracy that is higher than that of assistance data generated without the environmental information; and sending the first enhanced assistance data to the wireless-enabled device, the first enhanced assistance data configured to enable the wireless-enabled device to perform the one or more positioning operations using the first enhanced assistance data.

In some aspects of the present disclosure, a network apparatus is disclosed. In some embodiments, the network apparatus may include: one or more data communication interfaces configured to perform data communication with at least a user device in a wireless communication network; one or more memory; one or more processors communicatively coupled to the one or more data communication interfaces and the one or more memory, the one or more processors configured to: receive, at the network apparatus, first environmental information obtained by a wireless-enabled device of the wireless communication network; based at least on the first environmental information, generate first enhanced assistance data, the first enhanced assistance data comprising reference information having at least an accuracy that is higher than that of assistance data generated without the environmental information; and send the first enhanced assistance data to the wireless-enabled device, the first enhanced assistance data configured to enable the wireless-enabled device to perform one or more positioning operations using the first enhanced assistance data.

In some embodiments, the network apparatus may include: means for receiving, at the network apparatus, first environmental information obtained by a wireless-enabled device of the wireless communication network; means for, based at least on the first environmental information, generating first enhanced assistance data, the first enhanced assistance data comprising reference information having at least an accuracy that is higher than that of assistance data generated without the environmental information; and means for sending the first enhanced assistance data to the wireless-enabled device, the first enhanced assistance data configured to enable the wireless-enabled device to perform one or more positioning operations using the first enhanced assistance data.

In some aspects of the present disclosure, a non-transitory computer-readable medium is disclosed. In some embodiments, the non-transitory computer-readable medium includes a storage medium having instructions stored thereon, the instructions configured to, when executed by one or more processors, cause a network apparatus in a wireless communication network to: receive, at the network apparatus, first environmental information obtained by a wireless-enabled device of the wireless communication network; based at least on the first environmental information, generate first enhanced assistance data, the first enhanced assistance data comprising reference information having at least an accuracy that is higher than that of assistance data generated without the environmental information; and send the first enhanced assistance data to the wireless-enabled device, the first enhanced assistance data configured to enable the wireless-enabled device to perform one or more positioning operations using the first enhanced assistance data.

In some aspects of the present disclosure, a method of improving communication in a wireless communication network is disclosed. In some embodiments, the method may include: obtaining first environmental information using one or more sensors of a wireless-enabled device; sending the first environmental information to a network entity of the wireless communication network; receiving enhanced beamforming information from the network entity, the enhanced beamforming information generated based on the first environmental information sent to the network entity, the enhanced beamforming information comprising one or more characteristics of a plurality of available radio beams between a user device and a first base station of the wireless communication network, wherein the one or more characteristics enabling selection of a radio beam which realizes improved wireless communication between the user device and the first base station; and performing wireless communication using the enhanced beamforming information.

In some aspects of the present disclosure, a user device is disclosed. In some embodiments, the user device may include: one or more transceivers configured to perform data communication in a wireless communication network; one or more memory; one or more processors communicatively coupled to the one or more transceivers and the one or more memory, the one or more processors configured to: obtain first environmental information using one or more sensors of a wireless-enabled device; send the first environmental information to a network entity of the wireless communication network;

receive enhanced beamforming information from the network entity, the enhanced beamforming information generated based on the first environmental information sent to the network entity, the enhanced beamforming information comprising one or more characteristics of a plurality of available radio beams between a user device and a first base station of the wireless communication network, wherein the one or more characteristics enabling selection of a radio beam which realizes improved wireless communication between the user device and the first base station; and perform wireless communication using the enhanced beamforming information.

In some embodiments, the user device may include: means for obtaining first environmental information using one or more sensors of a wireless-enabled device; means for sending the first environmental information to a network entity of the wireless communication network; means for receiving enhanced beamforming information from the network entity, the enhanced beamforming information generated based on the first environmental information sent to the network entity, the enhanced beamforming information comprising one or more characteristics of a plurality of available radio beams between a user device and a first base station of the wireless communication network, wherein the one or more characteristics enabling selection of a radio beam which realizes improved wireless communication between the user device and the first base station; and means for performing wireless communication using the enhanced beamforming information.

In some aspects of the present disclosure, a non-transitory computer-readable medium is disclosed. In some embodiments, the non-transitory computer-readable medium includes a storage medium having instructions stored thereon, the instructions configured to, when executed by one or more processors, cause a user device in a wireless communication network to: obtain first environmental information using one or more sensors of a wireless-enabled device; send the first environmental information to a network entity of the wireless communication network; receive enhanced beamforming information from the network entity, the enhanced beamforming information generated based on the first environmental information sent to the network entity, the enhanced beamforming information comprising one or more characteristics of a plurality of available radio beams between a user device and a first base station of the wireless communication network, wherein the one or more characteristics enabling selection of a radio beam which realizes improved wireless communication between the user device and the first base station; and perform wireless communication using the enhanced beamforming information.

In some aspects of the present disclosure, another method of improving communication in a wireless communication network is disclosed. In some embodiments, the method may include: receiving, at a network entity, first sensed environmental information obtained by a wireless-enabled device of the wireless communication network; based at least on the first sensed environmental information, generating enhanced beamforming information having one or more characteristics of a plurality of available radio beams between a user device and at least a first base station of the wireless communication network, wherein the one or more characteristics enable selection of a radio beam which realizes improved wireless communication between the user device and the first base station; and sending the enhanced beamforming information to at least the wireless-enabled device, the enhanced beamforming information configured to enable the wireless-enabled device to perform wireless communication using the enhanced beamforming information.

In some aspects of the present disclosure, a network apparatus is disclosed. In some embodiments, the network apparatus may include: one or more data communication interfaces configured to perform data communication with at least a user device in a wireless communication network; one or more memory; one or more processors communicatively coupled to the one or more data communication interfaces and the one or more memory, the one or more processors configured to: receive, at the network apparatus, first sensed environmental information obtained by a wireless-enabled device of the wireless communication network; based at least on the first sensed environmental information, generate enhanced beamforming information by including one or more characteristics of a plurality of available radio beams between a user device and at least a first base station of the wireless communication network, wherein the one or more characteristics enabling selection of a radio beam which realizes improved wireless communication between the user device and the first base station; and send the enhanced beamforming information to at least the wireless-enabled device, the enhanced beamforming information configured to enable the wireless-enabled device to perform wireless communication using the enhanced beamforming information.

In some embodiments, the network apparatus may include: means for receiving, at the network apparatus, first sensed environmental information obtained by a wireless-enabled device of the wireless communication network; means for, based at least on the first sensed environmental information, generating enhanced beamforming information by including one or more characteristics of a plurality of available radio beams between a user device and at least a first base station of the wireless communication network, wherein the one or more characteristics enabling selection of a radio beam which realizes improved wireless communication between the user device and the first base station; and means for sending the enhanced beamforming information to at least the wireless-enabled device, the enhanced beamforming information configured to enable the wireless-enabled device to perform wireless communication using the enhanced beamforming information.

In some aspects of the present disclosure, a non-transitory computer-readable medium is disclosed. In some embodiments, the non-transitory computer-readable medium includes a storage medium having instructions stored thereon, the instructions configured to, when executed by one or more processors, cause a network apparatus in a wireless communication network to: receive, at the network apparatus, first sensed environmental information obtained by a wireless-enabled device of the wireless communication network; based at least on the first sensed environmental information, generate enhanced beamforming information by including one or more characteristics of a plurality of available radio beams between a user device and at least a first base station of the wireless communication network, wherein the one or more characteristics enabling selection of a radio beam which realizes improved wireless communication between the user device and the first base station; and send the enhanced beamforming information to at least the wireless-enabled device, the enhanced beamforming information configured to enable the wireless-enabled device to perform wireless communication using the enhanced beamforming information.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication network.

FIG. 3 is a diagram showing an example of a radio frequency (RF) sensing system.

FIG. 4 is a diagram showing an example of how beamforming may be performed, according to some embodiments.

FIG. 5 is a diagram of an example environment in which wireless-enabled devices may obtain information about the environment, according to some scenarios.

FIG. 6 is a signal flow diagram depicting signals that may be exchanged among a user equipment (UE), a base station, and a server to perform a positioning operation, according to some embodiments.

FIG. 7 is a signal flow diagram depicting signals that may be exchanged among a UE, a base station, and a server to perform a beamforming operation for wireless communication between the UE and the base station, according to some embodiments.

FIG. 8 is a block diagram illustrating an example transmission of signals between a UE and a server via LTE Positioning Protocol (LPP).

FIG. 9 is a block diagram illustrating an example transmission of signals between a base station and a server via NR Positioning Protocol A (NRPPa).

FIG. 10 is a flow diagram of a method of performing a positioning operation with respect to a user device in a wireless communication network, according to some embodiments.

FIG. 11 is a flow diagram of another method of performing a positioning operation with respect to a user device in a wireless communication network, according to some embodiments.

FIG. 12 is a flow diagram of a method of improving communication of a user device in a wireless communication network, according to some embodiments.

FIG. 13 is a flow diagram of another method of improving communication of a user device in a wireless communication network, according to some embodiments.

FIG. 14 is a block diagram of an embodiment of a UE, which can be utilized in embodiments as described herein.

FIG. 15 is a block diagram of an embodiment of a base station, which can be utilized in embodiments as described herein.

FIG. 16 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may absolute location determination, relative location determination, ranging, or a combination thereof. Such positioning may include and/or be based on timing, angular, phase, or power measurements, or a combination thereof (which may include RF sensing measurements) for the purpose of location or sensing services.

Various aspects relate generally to wireless communication and networking, and more particularly to obtaining and sharing of spatial perception information. Some aspects more specifically relate to sensing environmental information (e.g., using one or more sensors of a UE or a base station) and sending the environmental information to a location server or a sensing server. Non-environmental information may also be collected by the UE or base station and sent to the server as well. The server may then generate and send enhanced data generated based on the sensed environmental information and/or non-environmental information to the UE (or base station) for operations such as improved positioning operations or wireless communication. For example, the UE (or base station) may receive enhanced assistance data from the server which is more refined, precise, and optimized assistance data. In another example, the enhanced data can also relate to beamforming, more specifically to improving communications between a user device and a network device, such as a base station that the user device is initially in communication with or another base station other than one (depending on which is determined to be more optimal). Sensed environmental information (and/or non-environmental information) from a UE or a base station may be used by a server to generate enhanced beamforming information configuring a radio beam between the UE and the base station.

Particular aspects of the subject matter described in this disclosure can be implemented to realize one or more of the following potential advantages. Environmental awareness and perception can be used to optimize network parameters. In the case of improved positioning operations, enhanced assistance data may contain information that has a higher accuracy than that of assistance data generated without the environmental information. In an illustrative example, the location of a UE, especially in dense urban or indoor areas, could be improved using environmental information that is available to various and/or new types of sensors. In another illustrative example, UE sensors (e.g., camera) and their capabilities and perception-based reports may help in visual positioning. In the case of enhanced beamforming and improved communication, the enhanced beamforming information may enable, e.g., selection of an optimal radio beam between the user device and the base station. This can result in lower latency, higher bandwidth, higher data transmission rate, higher coverage, higher reliability, higher signal quality, etc. as compared to another radio beam selected without using the information from the UE or base station.

Additional details will follow after an initial description of relevant systems and technologies.

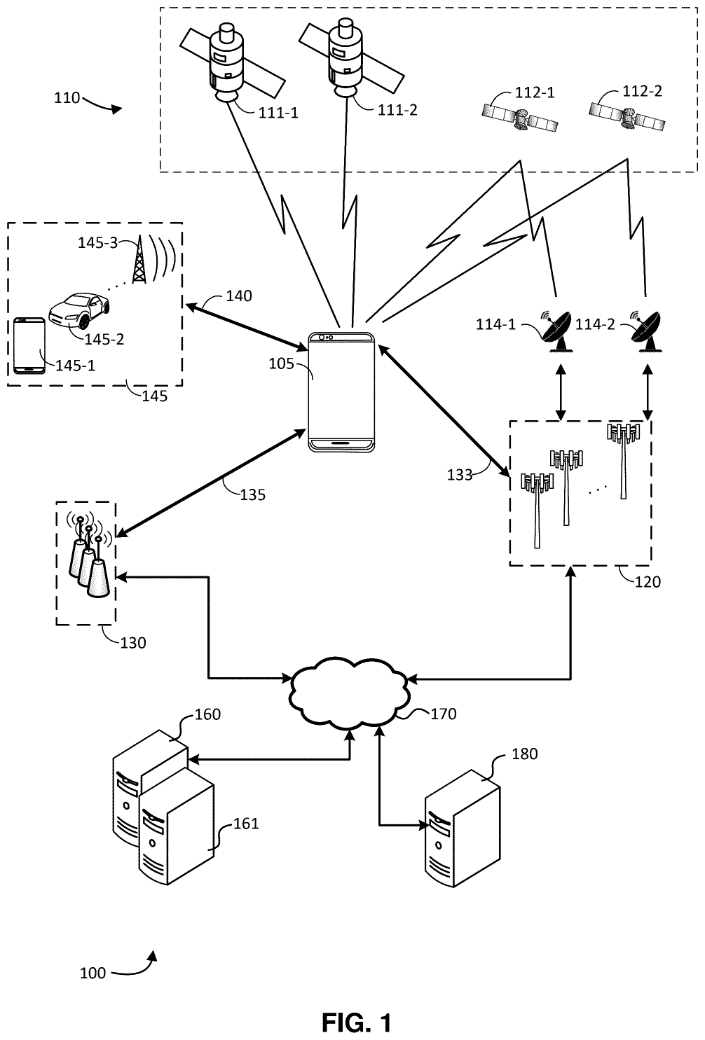

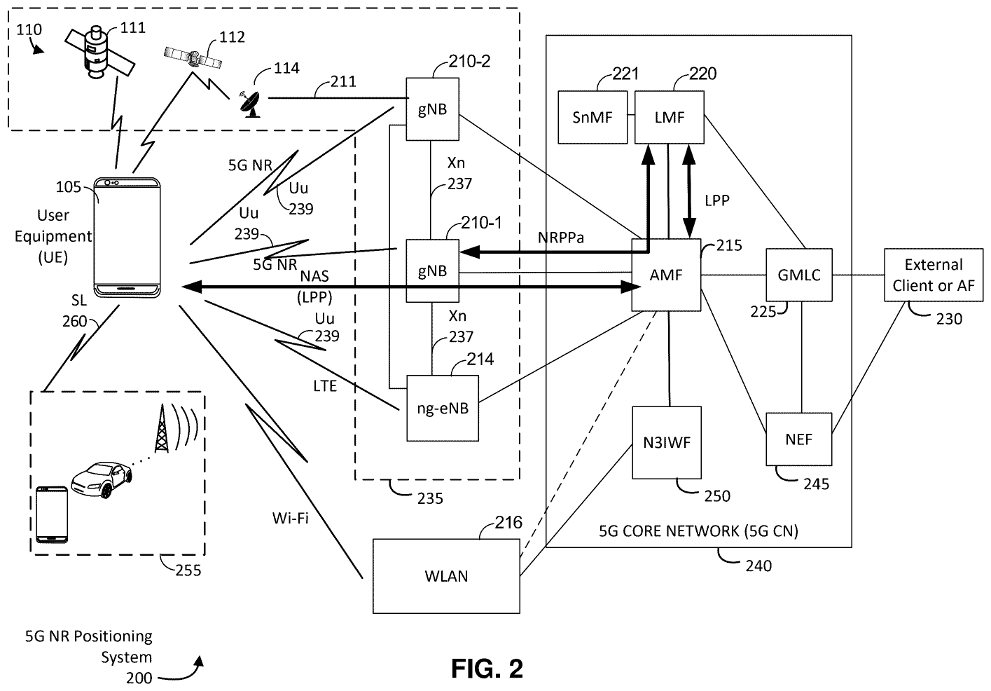

FIG. 1 is a simplified illustration of a positioning system 100 in which a UE 105, location server 160, and/or other components of the positioning system 100 can use the techniques provided herein for, e.g., performing a positioning operation with respect to a user device (e.g., UE 105) in a wireless communication network, or improving communication of a user device in a wireless communication network, according to some embodiments. The techniques described herein may be implemented by one or more components of the positioning system 100. The positioning system 100 can include: a UE 105; one or more satellites 110 (also referred to as space vehicles (SVs)), which may include Global Navigation Satellite System (GNSS) satellites 111 (e.g., satellites of the Global Positioning System (GPS), GLONASS, Galileo, Beidou, etc.) and/or Non-Terrestrial Network (NTN) satellites 112 (which are configured to act as communication nodes and may be separate and distinct from other SVs); one or more NTN gateways 114 (sometimes referred to herein simply as gateways 114, earth stations 114, or ground stations 114; base stations 120; access points (APs) 130; location server 160, sensing server 161, and/or another dedicated server (one or more of which may collectively be referred to herein as location server 160 in some instances); network 170; and external client 180. Generally put, the positioning system 100 can estimate a location of the UE 105 based on RF signals received by and/or sent from the UE 105 and known locations of other components (e.g., GNSS satellites 111, NTN satellites 112, base stations 120, APs 130) transmitting and/or receiving the RF signals. According to some embodiments, a sensing server may comprise a Sensing Management Function (SnMF). Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Accessing the location server 160 or the network 170 may also be done via the NTN satellite(s) 112 and earth station(s) 114, e.g., when direct access to base stations 120 are not available, or when positioning measurements (e.g., rough location signals) are desired. Additionally or alternatively, because APs 130 also may be communicatively coupled with the network 170 in certain implementations, UE 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station). In some cases, a base station 120 may contain no TRPs and may access UEs 105 only via one or more NTN gateways 114 and one or more NTN satellites 112. In such cases, the base station 120 may employ a wired (or wireless connection) to each NTN gateway 114, or an NTN gateway 114 may be part of the base station 120.

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates. With NTN access, a radio cell may be static (e.g., for a geostationary NTN satellite 112) or may have a coverage area that moves over the surface of the Earth (e.g., for a low Earth orbit (LEO) or medium Earth orbit (MEO) NTN satellite 112).

Satellites 110 may be utilized for positioning of the UE 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the UE 105 to perform code-based and/or carrier-based positioning, which can be highly accurate. Additionally or alternatively, satellites 110, such as NTN satellites 112, may be utilized for NTN-based positioning, in which satellites 110 may functionally operate as TRPs (or TPs) of a network (e.g., LTE and/or NR network) and may be communicatively coupled with network 170, e.g., via earth station(s) 114 configured for communication with base station(s) 120. In particular, reference signals (e.g., PRS) transmitted by satellites 110 (e.g., NTN satellites 112) for NTN-based positioning may be similar to those transmitted by base stations 120, and may be coordinated by a location server 160. In some embodiments, satellites 110 (e.g., NTN satellites 112) used for NTN-based positioning may be different than those used for GNSS-based positioning. In some embodiments, NTN nodes may include non-terrestrial vehicles, which may be in addition or as an alternative to NTN satellites 112.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 111, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., UE 105) may be facilitated using measurements from one or more anchor devices (e.g., mobile devices 145).

According to some embodiments, such as when the UE 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. The SnMF 221 (which may correspond with sensing server 161) may coordinate RF sensing by the 5G NR positioning/sensing system 200. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network.

The 5G NR positioning system 200 may further utilize information from satellites 110. As previously indicated, satellites 110 may comprise GNSS satellites 111 from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites 112 that may be communicatively coupled with the LMF 220 and may operatively function as a TRP (or TP) in the NG-RAN 235. NTN satellites 112 may then be in communication with one or more gNB 210, and UE 105 may be configured to communicate with the NG-RAN 235 via the satellites 112, earth station(s) 114, and gNB(s) 210. The gNB(s) 210 may be separate from earth station(s) 114. The gNB(s) 210 alternatively may include or may be combined with one or more earth station(s) 114, e.g., using a split architecture. Earth station(s) 114 may be shared by more than one gNB 210. An earth station 114 may be dedicated to just one Space Vehicle Operator (SVO) and to one associated constellation of NTN satellites 112 and hence may be owned and managed by the SVO. Earth station(s) 114 may be included within a gNB 210, e.g., as a gNB-DU within a gNB 210, which may occur when the same SVO or the same mobile network operator (MNO) owns both the gNB 210 and the included earth station(s) 114. Earth station(s) 114 may communicate with NTN satellite(s) 112 using control and user plane protocols that may be proprietary to an SVO. The control and user plane protocols between earth station(s) 114 and NTN satellite(s) 112 may: (i) establish and release earth station 114 to NTN satellite 112 communication link(s) 211, including supporting authentication and ciphering; (ii) update SV software and firmware; (iii) perform SV Operations and Maintenance (O&M); (iv) control radio beams and radio cells (e.g., direction, power, on/off status) and mapping between radio beams/radio cells and earth station uplink (UL) and downlink (DL) payload; and (v) assist with handoff of an NTN satellite 112 or radio cell to another earth station 114.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210 (e.g., which may occur via an NTN satellite 112 and an NTN gateway 114), which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105—e.g., which may be terrestrial or may occur via an NTN satellite 112 and an NTN gateway 114 with NTN access. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP Inter Working Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, NTN satellites 112, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, NTN satellite 112, and/or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, NTN satellite 112, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, NTN satellite 112, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214, NTN satellites 112, and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220, described in more detail hereafter.

Positioning of the UE 205 in a 5G NR positioning system 200 further may utilize measurements between the UE 205 and one or more other UEs 255 via a sidelink connection SL 260. As shown in FIG. 2, the one or more other UEs 255 may comprise any of a variety of different device types, including mobile phones, vehicles, roadside units (RSUs), other device types, or any combination thereof. One or more position measurement signals sent via SL 260 to the UE 205 from the one or more other UEs 255, to the one or more other UEs 255 from the UE 205, or both. Various signals may be used for position measurement, including sidelink PRS (SL-PRS). In some instances, the position of at least one of the one or more of the other UEs 255 may be determined at the same time (e.g., in the same positioning session) as the position of the UE 205. In some embodiments, the LMF 220 may coordinate the transmission of positioning signals via SL 260 between the UE 205 and the one or more other UEs 255. Additionally or alternatively, the UE 205 and the one or more other UEs 255 may coordinate a positioning session between themselves, without an LMF 220 or even a Uu connection 239 to an access node of the NG-RAN 235. To do so, the UE 205 and the one or more other UEs 255 may communicate messages via the SL 260 using sidelink positioning protocol (SLPP). In some scenarios, the one or more other UEs 255 may have a Uu connection 239 with an access node of the NG-RAN 235 and/or Wi-Fi connection with WLAN 216 when the UE 205 does not. In such instances, the one or more other UEs 255 may operate as relay devices, relaying communications to the network (e.g., LMF 220) from the UE 205. In such instances, a plurality of other UEs 255 may form a chain between the UE 205 and the access node.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station 120, NTN satellite 112, or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

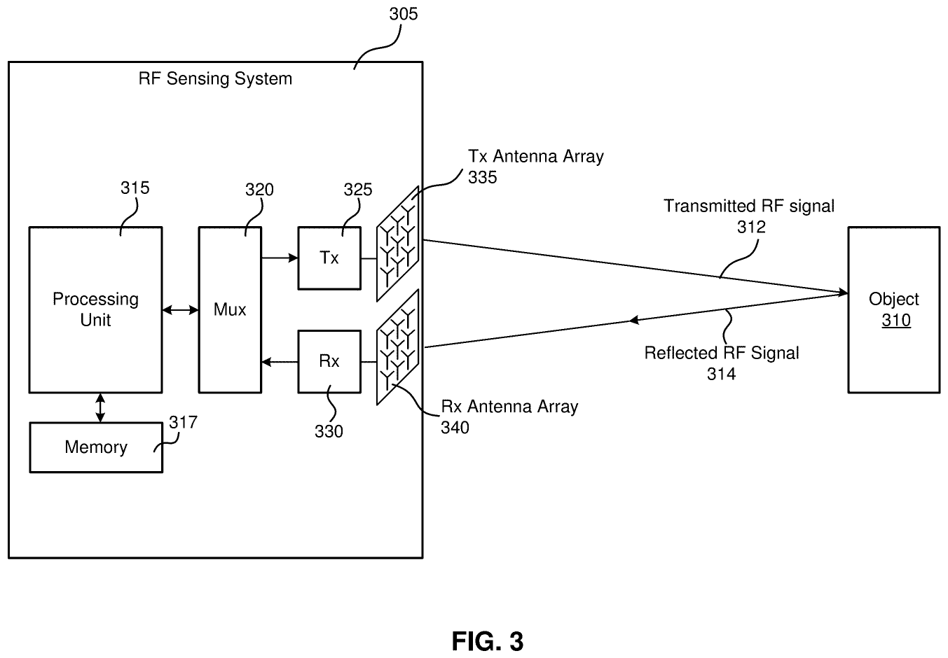

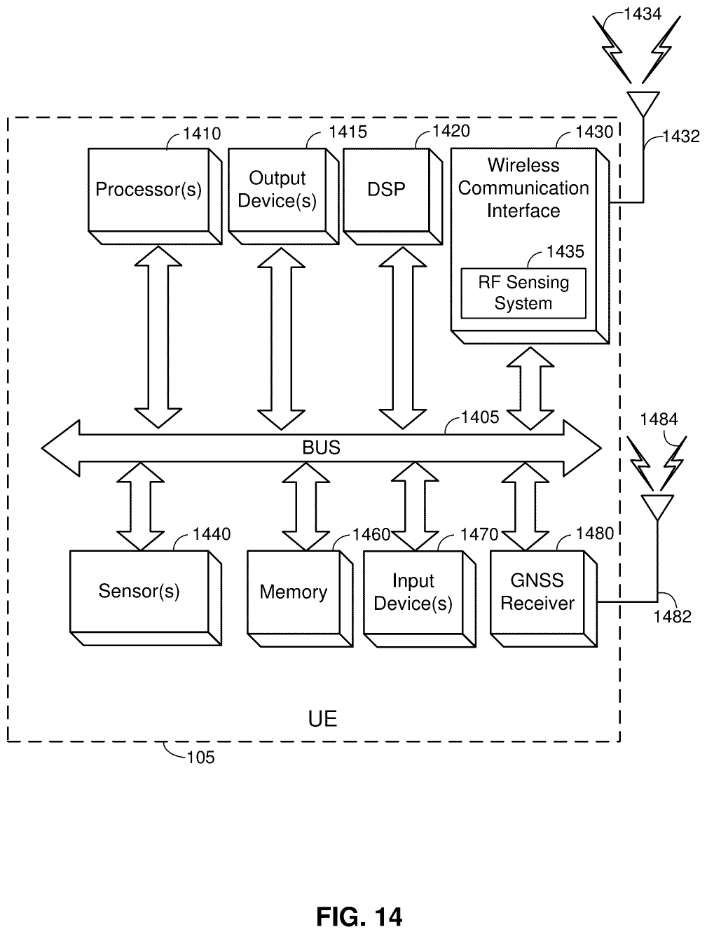

FIG. 3 is a diagram showing an example of an RF sensing system 305 and associated terminology. As used herein, the terms “waveform” and “sequence” and derivatives thereof are used interchangeably to refer to RF signals generated by a transmitter of the RF sensing system and received by a receiver of the RF sensing system for object detection. A “pulse” and derivatives thereof are generally referred to herein as waveforms comprising a sequence or complementary pair of sequences transmitted and received to generate a channel impulse response (CIR). The RF sensing system 305 may comprise a standalone device or may be integrated into a larger electronic device (e.g., the UE disclosed herein), such as a mobile phone, UE, a base station/access node, a satellite, or other type of sensing node as described herein. (Example components of such electronic devices are illustrated in FIGS. 14-16, discussed in detail hereafter.) It can be noted that although the example RF sensing system 305 of FIG. 3 is illustrated in a monostatic configuration, embodiments are not so limited. As noted elsewhere herein, RF sensing nodes may be configured to perform RF sensing in a monostatic, bistatic, or multi-static configuration, or any combination thereof (e.g., depending on the circumstances of a particular instance). As such, components of an RF sensing system 305 within an RF sensing node may vary. For example, RF sensing nodes performing only transmitting or only receiving during RF sensing may include only respective components related to the transmitting or receiving. Again, embodiments may vary, depending on desired functionality.

With regard to the functionality of the RF sensing system 305 in FIG. 3, the RF sensing system 305 can detect the distance, direction, and/or speed of objects of an object 310 by generating a series of transmitted RF signals 312 (comprising one or more pulses). Some of these transmitted RF signals 312 reflect off of the object 310, and these reflected RF signals 314 (or “echoes”) are then processed by the RF sensing system 305 using beamforming (BF) and digital signal processing (DSP) techniques to determine the object's location (azimuth, elevation, velocity (e.g., from Doppler measurements), and range) relative to the RF sensing system 305. CFAR may be part of this processing, but may not necessarily be used in every instance, or “occasion,” in which RF sensing is performed.

To enable RF sensing, RF sensing system 305 may include a processing unit 315, memory 317, multiplexer (mux) 320, Tx processing circuitry 325, and Rx processing circuitry 330. (The RF sensing system 305 may include additional components not illustrated, such as a power source, user interface, or electronic interface). It can be noted, however, that these components of the RF sensing system 305 may be rearranged or otherwise altered in alternative embodiments, depending on desired functionality. Moreover, as used herein, the terms “transmit circuitry” or “Tx circuitry” refer to any circuitry utilized to create and/or transmit the transmitted RF signal 312. Likewise, the terms “receive circuitry” or “Rx circuitry” refer to any circuitry utilized to detect and/or process the reflected RF signal 314. As such, “transmit circuitry” and “receive circuitry” may not only comprise the Tx processing circuitry 325 and Rx processing circuitry 330 respectively but may also comprise the mux 320 and processing unit 315. In some embodiments, the processing unit may compose at least part of a modem and/or wireless communications interface. In some embodiments, more than one processing unit may be used to perform the functions of the processing unit 315 described herein.

The Tx processing circuitry 325 and Rx circuitry 330 may comprise subcomponents for respectively generating and detecting RF signals. As a person of ordinary skill in the art will appreciate, the Tx processing circuitry 325 may therefore include a pulse generator, digital-to-analog converter (DAC), a mixer (for up-mixing the signal to the transmit frequency), one or more amplifiers (for powering the transmission via Tx antenna array 335), etc. The Rx processing circuitry 330 may have similar hardware for processing a detected RF signal. In particular, the Rx processing circuitry 330 may comprise an amplifier (for amplifying a signal received via Rx antenna 340), a mixer for down-converting the received signal from the transmit frequency, an analog-to-digital converter (ADC) for digitizing the received signal, and a pulse correlator providing a matched filter for the pulse generated by the Tx processing circuitry 325. The Rx processing circuitry 330 may therefore use the correlator output as the CIR, which can be processed by the processing unit 315 (or other circuitries). Processing of the CIR may include object detecting, range, speed, or direction of arrival (DoA) estimation.

Beamforming is further enabled by a Tx antenna array 335 and an Rx antenna array 340. Each antenna array 335, 340 comprises a plurality of antenna elements. It can be noted that, although the antenna arrays 335, 340 of FIG. 3 include two-dimensional arrays, embodiments are not so limited. Arrays may simply include a plurality of antenna elements along a single dimension that provides for spatial cancellation between the Tx and Rx sides of the RF sensing system 305. As a person of ordinary skill in the art will appreciate, the relative location of the Tx and Rx sides, in addition to various environmental factors can impact how spatial cancellation may be performed.

It can be noted that the properties of the transmitted RF signal 312 may vary, depending on the technologies utilized. Techniques provided herein can apply generally to “mmWave” technologies, which typically operate at 57-71 GHz, but may include frequencies ranging from 30-300 GHz. This includes, for example, frequencies utilized by the 802.11ad Wi-Fi standard (operating at 60 GHz). That said, some embodiments may utilize RF signals with frequencies outside this range. For example, in some embodiments, 5G frequency bands (e.g., 28 GHz) may be used.

Because RF sensing may be performed in the same frequency bands as communication (e.g., cellular and/or WLAN communication), hardware may be utilized for both communication and RF sensing, as previously noted. For example, one or more of the components of the RF sensing system 305 shown in FIG. 3 may be included in a wireless modem (e.g., Wi-Fi, 5G, or other modems). Additionally, techniques may apply to RF signals comprising any of a variety of pulse types, including compressed pulses (e.g., comprising Chirp, Golay, Barker, or Ipatov sequences) may be utilized. That said, embodiments are not limited to such frequencies and/or pulse types. Additionally, because the RF sensing system may be capable of sending RF signals for communication (e.g., using 802.11 communication technology), embodiments may leverage channel estimation used in communication for performing the RF sensing as provided herein. Accordingly, the pulses may be the same as those used for channel estimation in communication.

As noted, the RF sensing system 305 may be integrated into an electronic device in which RF sensing is desired. For example, the RF sensing system 305, which can perform RF sensing, may be part of communication hardware found in modern mobile phones. Other devices, too, may utilize the techniques provided herein. These can include, for example, other mobile devices (e.g., tablets, portable media players, laptops, wearable devices, other electronic devices (e.g., security devices, on-vehicle systems, specialized or dedicated RF sensing devices), wireless nodes of the communication network (e.g., access nodes, such as base stations and/or satellites), or the like. That said, electronic devices (e.g., RF sensing nodes) into which an RF sensing system 305 may be integrated are not limited to such devices.

In RF sensing, a wireless signal can be transmitted from one or multiple transmit points and received at one or multiple receive points after being reflected off a target. RF sensing can enable many candidate applications, including intruder detection, animal/pedestrian/unmanned aerial vehicle (UAV) intrusion detection in highways and railways, rainfall monitoring, flooding awareness, autonomous driving, automated guided vehicle (AGV) detection/tracking/collision avoidance, smart parking and assistance, UAV trajectory and tracking, crowd management, sleep/health monitoring, gesture recognition, XR streaming, public safety, search and rescue, and more. Further, RF sensing is expected to be incorporated into wireless standards (e.g., 6G), and therefore may be performed in the future in a cellular network.

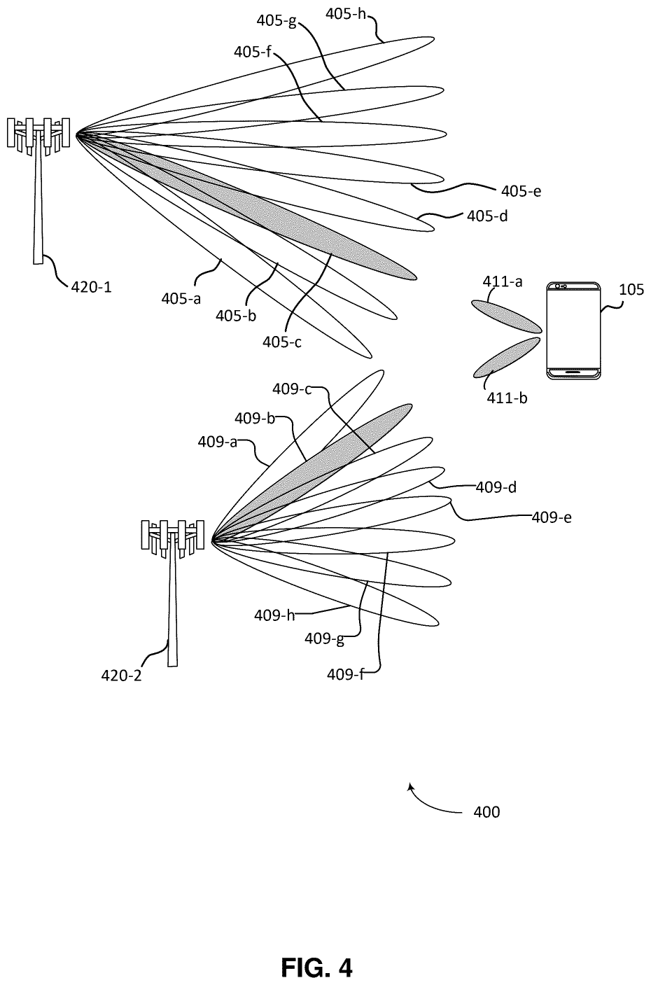

FIG. 4 is a diagram illustrating a simplified environment 400 including two base stations 420-1 and 420-2 (which may correspond to base stations 120 of FIG. 1 and/or gNBs 210 and/or ng-eNB 214 of FIG. 2) with antenna arrays that can perform beamforming to produce directional beams for transmitting and/or receiving RF signals. FIG. 4 also illustrates a UE 105, which may also use beamforming for transmitting and/or receiving RF signals. Such directional beams are used in 5G NR wireless communication networks. Each directional beam may have a beam width centered in a different direction, enabling different beams of a base station 420 to correspond with different areas within a coverage area for the base station 420.

Different modes of operation may enable base stations 420-1 and 420-2 to use a larger or smaller number of beams. For example, in a first mode of operation, a base station 420 may use 16 beams, in which case each beam may have a relatively wide beam width. In a second mode of operation, a base station 420 may use 64 beams, in which case each beam may have a relatively narrow beam width. Depending on the capabilities of a base station 420, the base station may use any number of beams the base station 420 may be capable of forming. The modes of operation and/or number of beams may be defined in relevant wireless standards and may correspond to different directions in either or both azimuth and elevation (e.g., horizontal and vertical directions). Different modes of operation may be used to transmit and/or receive different signal types. Additionally or alternatively, the UE 105 may be capable of using different numbers of beams, which may also correspond to different modes of operation, signal types, etc.

In some situations, a base station 420 may use beam sweeping. Beam sweeping is a process in which the base station 320 may send an RF signal in different directions using different respective beams, often in succession, effectively “sweeping” across a coverage area. For example, a base station 420 may sweep across 120 or 360 degrees in an azimuth direction, for each beam sweep, which may be periodically repeated. Each direction beam can include an RF reference signal (e.g., a PRS resource), where base station 420-1 produces a set of RF reference signals that includes Tx beams 405-a, 405-b, 405-c, 405-d, 405-e, 405-f, 405-g, and 405-h, and the base station 420-2 produces a set of RF reference signals that includes Tx beams 409-a, 409-b, 409-c, 409-d, 409-e, 409-f, 409-g, and 409-h. As noted, because UE 105 may also include an antenna array, it can receive RF reference signals transmitted by base stations 420-1 and 420-2 using beamforming to form respective receive beams (Rx beams) 411-a and 411-b. Beamforming in this manner (by base stations 420 and optionally by UEs 105) can be used to make communications more efficient. They can also be used for other purposes, including taking measurements for position determination (e.g., AoD and AoA measurements).

As discussed herein, in some embodiments, TDOA assistance data may be provided to a UE 105 by a location server (e.g., location server 160) for a “reference cell” (which also may be called “reference resource”), and one or more “neighbor cells” or “neighboring cells” (which also may be called a “target cell” or “target resource”), relative to the reference cell. For example, the assistance data may provide the center channel frequency of each cell, various PRS configuration parameters (e.g., NPRS, TPRS, muting sequence, frequency hopping sequence, PRS ID, PRS bandwidth), a cell global ID, PRS signal characteristics associated with a directional PRS, and/or other cell related parameters applicable to TDOA or some other position method. PRS-based positioning by a UE 105 may be facilitated by indicating the serving cell for the UE 105 in the TDOA assistance data (e.g., with the reference cell indicated as being the serving cell).

In some embodiments, TDOA assistance data may also include “expected Reference Signal Time Difference (RSTD)” parameters, which provide the UE 105 with information about the RSTD values the UE 105 is expected to measure at its current location between the reference cell and each neighbor cell, together with an uncertainty of the expected RSTD parameter. The expected RSTD, together with the associated uncertainty, may define a search window for the UE 105 within which the UE 105 is expected to measure the RSTD value. TDOA assistance information may also include PRS configuration information parameters, which allow a UE 105 to determine when a PRS positioning occasion occurs on signals received from various neighbor cells relative to PRS positioning occasions for the reference cell, and to determine the PRS sequence transmitted from various cells in order to measure a signal ToA or RSTD.

Using the RSTD measurements, the known absolute or relative transmission timing of each cell, and the known position(s) of wireless node physical transmitting antennas for the reference and neighboring cells, the UE position may be calculated (e.g., by the UE 105 or by the location server 160). More particularly, the RSTD for a neighbor cell “k” relative to a reference cell “Ref,” may be given as (ToAₖ−ToA_{Ref}), where the ToA values may be measured modulo one subframe duration (1 ms) to remove the effects of measuring different subframes at different times. ToA measurements for different cells may then be converted to RSTD measurements and sent to the location server 160 by the UE 105. Using (i) the RSTD measurements, (ii) the known absolute or relative transmission timing of each cell, (iii) the known position(s) of physical transmitting antennas for the reference and neighboring cells, and/or (iv) directional PRS characteristics such as a direction of transmission, the UE 105 position may be determined.

### Environmental Perception and Sensing

A wireless network such as the positioning system 100 depicted in FIG. 1 or the 5G NR positioning system 200 depicted in FIG. 2 may have myriad objects and features and even physical properties that can be perceived. As but one example, a user device (e.g., UE) in a given environment (e.g., outdoor or indoor) may be surrounded by buildings, landscape, walls, furniture, people, street signs, natural obstructions (e.g., trees, bushes), vehicles, other UEs, cellular towers, etc. Information about the environment which can be sensed and perceived by one or more sensors of a device (e.g., a UE or a base station (e.g., gNB)) may be referred to as environmental information. In some embodiments, the environmental information may be obtained by one or more sensors of the device, while in some implementations, the environmental information may be obtained by one or more discrete or standalone sensors, such as those installed at another type of device (e.g., access points) or on stationary locations (e.g., mounted on a wall, ceiling, scaffolding, or other structure). Environmental information may then be sent to another device such as a UE or base station. Such environmental information may also be sent to a server of the network (e.g., location server 160, sensing server 161) from a UE (or a base station or a discrete sensor) that is capable of obtaining environmental information.

In various embodiments, there are numerous types of environmental information that can be obtained by one or more sensors (e.g., of a UE or a base station). Examples of environmental information may include:

A type of local environment (e.g., indoor, type of building, outdoor, dense urban, urban, suburban, rural).

Audio data (e.g., volume, type of audio including voice, traffic, machinery, music, wind, etc.).

Acoustic data (e.g., ultrasound signals).

Object information proximate to the UE or base station (e.g., people, pedestrians, furniture, vehicles, trees, bushes, buildings, street signs), which may include positions of nearby base stations, other UEs, reflectors, etc. This may indicate a blockage event, its timing and duration, and affected radio beam paths. This may also include size and distance information (e.g., size of a room the UE is located in, distance(s) to visible building(s)). In some cases, object information may include street and road information. Information about the presence of other network devices such as base stations, other UEs, or reflectors, and their distances and/or positions (which may be obtained through data mentioned below) can also indicate, for example, that a handover may be required at a certain time or location, and the timing for the handover.

Spatial sensing data, including radio frequency (RF) data (e.g., ambient radiated RF power in different frequency bands, directions of radiation, signal power or quality (including RF map), solar radiation or intensity). In some implementations, Wi-Fi sensing may be performed to obtain the RF data. Wi-Fi sensing may involve the UE transmitting signals and detecting reflections and scattering, or receiving signals from surrounding nodes, which may allow the UE to determine information about its local environment. Wi-Fi signals may be monostatic, in which a device (e.g., UE) sends and/or receives signals, or bistatic, in which the devices receives signals transmitted by another device such as an access point. The UE may then make inferences or determinations that there are objects or people nearby in the local environment or otherwise proximate to the UE (e.g., within a certain distance). As part of the environmental information, in some approaches, the UE may send to the server all or portion(s) of the determined raw information such as raw sensor data (e.g., Wi-Fi sensing data), configuration information obtained based on the raw sensor data, or the inferences made based on the raw information (e.g., sensor data) to the server. The server may match the sensed information (e.g., Wi-Fi sensing data) with information that may be known to the server, previously obtained information, and/or crowdsourced information (e.g., from one or more UEs in the network other than the UE currently sending the environmental information). Known information may include known locations of objects such as buildings and natural obstructions (e.g., trees) or known road layouts and navigation data, which can be used for matching the sensed information and/or verifying the accuracy of the sensed information.

Visual data such as camera images, which may include at least some of the above, e.g., objects, buildings, roads, natural objects such as trees.

Infrared (e.g., heat-based) image data.

Other optical data such as ultraviolet data.

Non-environmental types of information, such as capability information of the UE or base station including sensors that the UE or base station possesses. The capability information may be encapsulated in a capability message and indicate what kind of perception or environmental awareness the UE or base station is capable of obtaining.

In some implementations, location information of the UE may be based on location sensors or satellite data (e.g., from GNSS satellites and/or NTN satellites). In some implementations, location information of the UE may be UE-assisted, UE-based, or network based. Such location information in some cases may be considered rough or coarse location(s) with an accuracy of the position that is below a prescribed threshold or less than other types of location information (such as location information determined based on enhanced assistance data to be discussed below).

Above types of information obtained at different locations at different times, including location information of a UE at different times.

Above types of information obtained from multiple sensing UEs and/or base stations within a particular region.

Above types of information obtained from one or more discrete sensors.

In some implementations, other types of non-environmental information, such as inertial, motion, velocity, acceleration, rotation, direction, orientation data (and/or other physical properties) associated with the UE can be obtained using the one or more sensors of the UE (e.g., IMU and/or 6DOF sensors) and provided to a network entity (e.g., server). As with the environmental information, these types of non-environmental information can be obtained at different times or locations.

As will be described below, environmental and non-environmental information may be used to determine information (e.g., enhanced assistance data or enhanced beamforming information) for different operations such as positioning operations or beamforming.

Examples of environmental and non-environmental information that can be obtained by one or more sensors are provided in the below table:

TABLE 1
Example types of environmental information and non-
environmental information that can be obtained.

| ENVIRONMENTAL | NON-ENVIRONMENTAL |
|---|---|
| INFORMATION | INFORMATION |
| Type of environment | Inertial data |
| Audio data | Motion data |
| Acoustic data | Velocity data |
| Proximate object information (including | Acceleration data |
| presence of other network devices) | |
| Spatial or RF data | Rotation data |
| Visual data | Capability (including sensor |
| | capability) |
| Optical data | Location (coarse) |
| Infrared data | Orientation and direction |
| | data |
| Ultraviolet data | |
| Information obtained from multiple UEs or | |
| multiple base stations | |
| Information obtained from discrete sensor(s) | |

Information obtained at different locations
Information obtained at different times

In some embodiments, one or more of the above types of information (and/or configuration information obtained based on the sensed environmental information) may be sent to other portions of the network. In some examples, a UE (or base station) may send the sensed environmental information and/or configuration information to a server of the network, such as a location server. The UE may send the sensed environmental information and/or configuration information via an intermediary device such as a base station (e.g., gNB).

It will be understood that the information used to determine enhanced information is not limited to the examples listed in Table 1. Other known information, such as environmental and non-environmental data stored elsewhere (e.g., server, database, remote storage, other storage) can be accessible and usable as well. Street information, navigation information, known structures, and time of day, may be some examples of information known or already accessible, e.g., by the server.

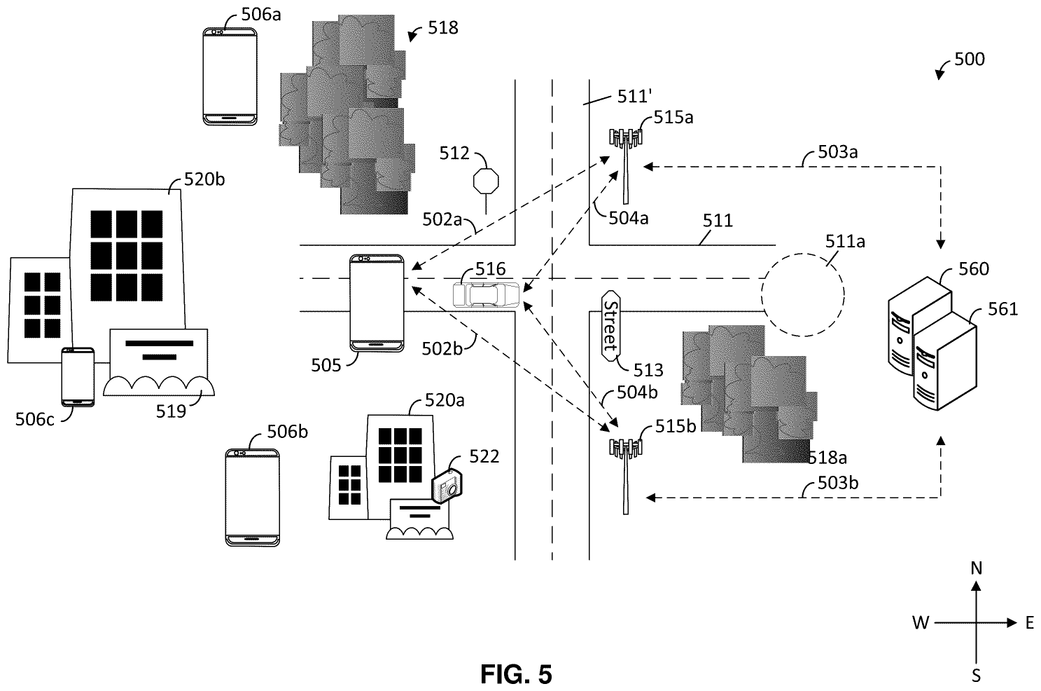

To illustrate how the above example environmental information can be obtained, FIG. 5 illustrates an example environment 500 in which wireless-enabled devices may obtain information about the environment, according to some scenarios. The example environment 500 may include one or more UEs 505, 506a, 506b configured for wireless data communication with one or more base stations 515a, 515b in a wireless network. There may be other nodes such as access points, reflectors, relay devices, etc. The one or more base stations 515a, 515b may be configured for data communication with one or more servers, such as a location server 560 and/or a sensing server 561, e.g., via the infrastructure described with respect to FIG. 1 or 2, which may include communication links 503a, 503b.

UEs 505, 506a, 506b, 506c may include one or more sensors. In some implementations, a sensor may be a visual sensor (e.g., a camera), an optical sensor (e.g., infrared sensor, ultraviolet sensor, lidar sensor), an RF sensor (e.g., radar), an acoustic sensor (e.g., microphone, ultrasound sensor), or a location sensor (e.g., GNSS sensor, GPS sensor). In some implementations, a sensor may be configured to detect information about the UE, such as an IMU (e.g., accelerometer, gyroscope) or a 6DOF sensor, which may obtain non-environmental information such as a property of the UE (e.g., inertia, motion, velocity, acceleration, rotation, etc.). Each UE may be capable of obtaining different types of information, such as a combination of the above types of information. Some UEs in the network may not be capable of obtaining the above types of information. Base stations 515a, 515b may include one or more sensors having similar capabilities. Some base stations in the network may not have such capabilities to obtain the above types of information. However, the UEs 505, 506a, 506b, 506c and the base stations 515a, 515b may be configured to obtain at least one of the above types of information, recognizing that different UEs and base stations may have different types of sensors and capabilities.

UEs 505, 506a, 506b, 506c may include a wireless communication interface that may be configured to communicate with base station 515a via a communication link 502a and/or with base station 515b via a communication link 502b. In certain implementations, a vehicle 516 on a road 511 within the example environment 500 may include one or more sensors of the types mentioned above, or may include a UE having one or more sensors. In addition, the vehicle 516 or the UE installed therein may be capable of performing data communication with the base station 515a, 515b as well via a wireless communication interface, e.g., via respective communication links 504a, 504b. In some configurations, the vehicle 516 or its UE may perform sidelink or similar D2D (e.g., V2X) communications (e.g., with other vehicles or UEs) as described above. Similarly, UEs 505, 506a, 506b, 506c may be configured to perform sidelink communication with one another.

Example environment 500 may include myriad objects throughout. For example, a traffic sign 512 and a street sign 513 may be placed along the road 511. These signs may be visually observable and perceivable by a sensor of the UE 505, e.g., a camera. The road 511 itself along with any intersections 511′ and lanes may also be perceived by the sensor of the UE 505. As another example, natural objects and obstructions such trees 518 or a bush 519 may be present. UE 506a may sense the trees 518. In some scenarios, the UE 506a may not be able to communicate with the base station 515a if the trees 518 sufficiently interfere with signals between the UE 506a and the base station 515a. UE 506a may also not be able to perceive the traffic sign 512. Similarly, other obstructions such as buildings 520a, 520b may be present. Such buildings may similarly occlude visual or beamforming paths between a UE and other devices such as a base station. UEs 506b, 506c may not be able to sense objects or other information or communicate with a base station because of buildings 520a, 520b or bush 519. In some scenarios, UE 506c may be able to obtain information relating to the type of environment, e.g., whether UE 506c is indoor (e.g., inside building 520b) or outdoor.

In some cases, a discrete sensor 522 may be present. The discrete sensor 522 may not be associated with a UE or a base station. However, discrete sensor 522 may be able to obtain visual, optical, acoustic, RF, and/or location data or other types of information as listed above. This information may be sent to the location server 560 and/or the sensing server 561 via a network.

Environment awareness gained by a server based on the information received from a UE or base station may be used to improve or optimize network parameters (e.g., at the server) to improve aspects of positioning or communication with respect to the UE.

In some embodiments, enhanced positioning may be performed. In some implementations, the server may be configured to generate, improve, and/or modify assistance data using the environmental information and/or non-environmental information (received, e.g., from a UE or from a base station (e.g., gNB)). Such assistance data may be referred to herein as enhanced assistance data, which can be useful for positioning of a target UE. Enhanced assistance data can improve location accuracy and reliability of the location of a target UE (e.g., the sending UE, or in crowdsourcing approaches, another UE). More specifically, the enhanced assistance data may include reference information having at least an accuracy that is higher than that of assistance data generated without the sensed environmental information. Alternatively or additionally, precision, error, standard deviation, and/or other metrics including a metric of confidence may also be higher in the enhanced assistance data. Some examples of reference information within the enhanced assistance data can include information that can assist with positioning, such as reference times (e.g., transmission, arrival) associated with sending or receiving signals (e.g., PRS or other reference signals), reference positions of nodes or network devices sending or receiving signals, satellite ephemeris (including satellite position and velocity state information over a period of time), clock information, and/or clock correction information. Some examples of reference information within the enhanced assistance data can include information that can assist with measurements, such as reference times of signals sent and received, satellite identifiers, Doppler frequency information associated with satellite signal, and/or code phase.

Based on the environmental information and/or non-environmental information, the accuracy of such reference information can be improved. As illustrative examples, the type of environment can inform the server whether there is more or less likely to be multipath or blockage events; visual data can confirm a location of a UE or estimate a distance of a UE from a known landmark or location; motion data, velocity data, and/or direction data can indicate a change in position of the UE over time. This information can enable better estimation of, for instance, reference times of signals exchanged and UE position at a current time, future time, or a previous time. In some implementations, the resulting enhanced assistance data may have lower uncertainties or errors (and thus, higher accuracy and/or precision) associated therewith. The location of the UE may thereby be improved even in dense urban and indoor areas, by leveraging the environmental information and/or non-environmental information obtainable by sensor(s) of the UE or a base station. As capabilities of UEs and other network equipment improve, so do the types and precision of environmental and non-environmental information that can be used to improve the assistance data, which can even “future-proof” this approach of improving the positioning of the UE along with further advancements in capabilities and means of obtaining environmental and non-environmental information.

Some examples of enhanced assistance data generation and provision to a UE by a location server based on environmental information and/or non-environmental information received by the location server from the UE or a from a serving base station for the UE are as follows. In an Example A, the environmental information and/or non-environmental information indicates nearby objects to a UE such as people, vehicles and/or buildings and a direction or directions from the UE to the nearby objects. Knowing an approximate location for the UE, the location server can send enhanced assistance data to the UE to assist the UE in measuring signals S1 from base stations which arrive at the UE from directions that are different from the directions of the nearby objects, and not to assist the UE in measuring signals S2 from other base stations which arrive at the UE from directions that are the same as the directions of the nearby objects, due to a probability that the signals S2 will be blocked or attenuated by the nearby objects and thereby lead to no measurements or to less accurate measurements for the signals S2. In some implementations, the information about nearby objects and probability of blockage or attenuation (e.g., a probability that exceeds a probability threshold that is indicative of inaccurate measurements) can be used by the server to configure assistance data with, among other things, (i) direction, timing, distance, angular, etc. information relating to base stations from which signals S1 can be measured, (ii) direction, timing, distance, angular, etc. information relating to base stations from which signals S2 should not be measured, (iii) information about base stations (those from which signals S1 can be measured, and in some cases, those from which signals S2 can be measured) and their absolute locations and/or locations relative to the UE, (iv) a list and/or ranking of base station(s) from which signals will exceed an accuracy threshold and base station(s) from which signals will not exceed an accuracy threshold, which can assist the UE in selecting an advantageous base station with the highest signal strength, closest distance, uptime/availability and downtime percentage, reliability, etc. (each of which may be ranked), (v) an instruction to obtain measurements with respect to certain base station(s) such as base stations from which signals S1 can be measured, or (vi) a combination thereof, which can result in the enhanced assistance data that is sent to the UE and assists the UE in measuring at least signals S1 that have reliable paths and lines of sight for measurements.

In an Example B, the environmental information and/or non-environmental information indicates that the UE is indoors or under partial overhead cover (e.g., of trees or buildings). The location server can then send enhanced assistance data to the UE to assist the UE to measure signals from terrestrial base stations and Wi-Fi APs but not from GNSS or communication satellites, due to a likelihood that signals from the GNSS or communication satellites will be blocked or attenuated by a building in which the UE is located when indoors or by other objects when the UE has partial overhead cover. In some implementations, the server may configure assistance data with, among other things, (i) direction, timing, distance, angular, etc. information relating to the Wi-Fi APs, (ii) direction, timing, distance, angular, etc. information relating to communication satellites, from which measurements should not be obtained, (iii) information about the Wi-Fi APs and their absolute locations and/or locations relative to the UE, (iv) a list and/or ranking of the Wi-Fi APs, which can assist the UE in selecting an advantageous Wi-Fi AP with the highest signal strength, closest distance, uptime/availability and downtime percentage, reliability, etc. (each of which may be ranked), (v) an instruction to obtain measurements with respect to certain Wi-Fi AP(s), or (vi) a combination thereof, which can result in the enhanced assistance data that is sent to the UE and assists the UE in measuring at least signals with respect to the APs and not the satellites.

In an Example C, the environmental information and/or non-environmental information may indicate that the UE is in a jacket pocket or backpack of a user, with reduced ability to receive signals from base stations and GNSS satellites. The location server can then send enhanced assistance data to the UE to assist the UE to measure only the strongest signals from nearby base stations and Wi-Fi APs based on an initial approximate location for the UE. In some implementations, the server may configure assistance data with information similar to those listed with Example B to generate enhanced assistance data that is sent to the UE and assists the UE in measuring at least signals with respect to the APs and not the satellites.

In an Example D, the non-environmental information (e.g., inertial, motion, velocity data) may indicate that the UE is moving at high speed (e.g., in a car or train). The location server can then send enhanced assistance data to the UE to assist the UE to measure signals from base stations (e.g., macro base stations) that have a large coverage area where there is a high likelihood that even after moving at high speed, the signals can still be received and measured by the UE. In some implementations, the non-environmental information and the information about the likelihood can be used by the server to configure assistance data with, among other things, (i) direction, timing, distance, angular, etc. information relating to the base stations with the high likelihood, from which signals can be well received and measured by the UE, (ii) direction, timing, distance, angular, etc. information relating to base stations that do not have the high likelihood, from which signals should not be measured, (iii) information about base stations with the high likelihood (and in some cases, base stations without the high likelihood), (iv) a list and/or ranking of base station(s) with the high likelihood and base station(s) without the high likelihood, which can assist the UE in selecting an advantageous base station with large coverage, (iv) an instruction to obtain measurements with respect to certain base station(s) such as base stations with the high likelihood, or (vi) a combination thereof, which can result in the enhanced assistance data that is sent to the UE and assists the UE in measuring at least signals with respect to base stations with high coverage and/or high likelihood of measurement even at high velocity (or other types of motion determined by the non-environmental information, including irregular types of movements that can be covered by, e.g., high-coverage base stations).

In an Example E, the environmental information may indicate that the UE has a high level of RF interference at certain frequencies at its current location. The location server can then send enhanced assistance data to the UE to assist the UE to measure signals from base stations that use frequencies different from the frequencies where there is high RF interference at the UE location. In some implementations, environmental RF data can be used by the server to configure assistance data with, among other things, (i) direction, timing, distance, angular, etc. information relating to the base stations using different, non-interfering frequencies, from which signals can be well received and measured by the UE, (ii) direction, timing, distance, angular, etc. information relating to base stations that use interfering frequencies, from which signals should not be measured, (iii) information about base stations using the different frequencies (and in some cases, base stations using the interfering frequencies), (iv) a list and/or ranking of base station(s) using the different frequencies and base station(s) using the interfering frequencies, which can assist the UE in selecting an advantageous base station without interference, (iv) an instruction to obtain measurements with respect to certain base station(s) such as base stations with the different frequencies, or (vi) a combination thereof, which can result in the enhanced assistance data that is sent to the UE and assists the UE in measuring at least signals with respect to base stations with a low probability of interference.

In implementations that use a crowdsourcing approach, location accuracy and reliability may be improved for one or more UEs in the network other than the UE(s) sending environmental information. Environmental data received from multiple UEs may be crowdsourced to determine a body of environmental information. For example, the location server may collect and analyze environmental (and/or non-environmental) information received from multiple UEs to determine or update the body of crowdsourced environmental (and/or non-environmental) information. In some instances, environmental data received from multiple base stations may be part of the body of environmental information. In some cases, such a body of environmental information may have a greater amount of information than environmental information collected by a given UE or a given base station, thus providing more contextual information to the server for generating the enhanced assistance data, potentially further enhancing the accuracy and reliability of the positioning of a target UE. The target UE may be any one of the UE(s) sending environmental information or the one or more other UEs. In addition, in some implementations, at least portion(s) of the crowdsourced body of environmental information may be sent to a given UE or a given base station. In some implementations, the server can query or send a request to one or more wireless-enabled devices (e.g., UE(s), base station(s)) for additional information such as additional environmental information.

In some embodiments, the server can utilize the crowdsourced environmental information obtained from multiple UEs (e.g., using sensor-perception capabilities of one or more sensors) to generate, maintain, and/or update a map (or other data structure visualizing or representing a particular region, e.g., where the sensing UEs are or were at the time of sensing) that is representative of coverage and/or various perceptions, which can be used for location determination and/or cross-checking measurements provided by UEs. In some cases, non-environmental information may also be crowdsourced from multiple UEs as noted above and used to generate the map or other data structure. In some implementations, the map may include user-perceivable positions (x, y, z) and/or orientation or pose of anchor points within the environment (which may represent signal sources such as an antenna at a base station or an RF reflector). In some cases, the map may be an RF map representing the environment based on the signal sources. In some implementations, the map may also include information regarding signals received from base stations (e.g., the quality of the signals and communication) and other conditions of the network. For example, the map may represent signal quality (e.g., RSRP, SINR, CQI) of anchor points. In some configurations, the map may appear to be a heatmap where locations of anchor points (e.g., base stations, UEs, relay points, reflectors, repeaters) and associated signal quality and/or signal range are represented with different colors. Blockage caused by objects may affect such signal quality and range. In some configurations, the map may be a three-dimensional representation or a two-dimensional (top-down) representation, or other topographical representations. In some configurations, a user may be able to interact with the map (e.g., zoom in/out, rotate, move, reveal additional information about an object (e.g., precise locations, geodetic or satellite coordinates, names, signal strength of an anchor point) or obscure it).

In some approaches, the map may help determine the position of a target UE directly without initiating sessions with other network nodes, or the target UE can directly use or access at least portions of map data to determine its position. In some approaches, the map may help determine suitable base stations to be used at different locations, e.g., for improved beamforming or selection of base station for optimal communication with the UE. For example, in some cases, a user may manually select a base station by visualizing network conditions, presence of occluding objects, and so on. However, in some cases, the server may send an instruction to a base station that the UE should be handed off to another base station because the other base station will likely provide better coverage, quality, bandwidth, or other favorable signal characteristic, thereby improving the wireless communication of the UE. In some approaches, the map may help determine the position of a target UE without receiving signals from satellites, which would be especially useful for locating a UE who does not support a satellite receiver, such as a UE that does not support a GNSS receiver or a device with low memory (e.g., an IoT device).

In some embodiments, enhanced beamforming or enhanced data communication may be performed between a UE and a base station. As described above, a UE may obtain environmental information using its sensor(s). In some instances, the UE may use the environmental information to select a radio beam relative to a base station, and optimize its own beam selection or beamforming mechanism. In some approaches, the environmental information used for beamforming may be received from the base station, e.g., environmental information obtained by the base station. In some cases, the environmental information used may be derived at least in part from both the UE itself or from the base station. Similarly, a base station (e.g., gNB) may select the beam and optimize its beam selection or beamforming mechanism relative to the UE, based on environmental information that the base station obtains using its sensor(s) and/or based on environmental information that the base station receives from the UE. That is to say, the UE may send the environmental information obtained by its sensor(s) to a base station so that the base station can optimize the base station's beam selection, and the base station may use its sensor(s) to obtain environmental awareness information and send the environmental information to the UE to optimize the UE's beam selection.

Information about the environment (e.g., local to a UE) can be sensed by the UE and provided to a base station (e.g., gNB) to enable the base station to perform RF sensing differently or improve communication with UE (e.g., by improving beam selection with the UE). For example, the environmental information can indicate or determine obstacles, obstructions, or other objects in area that could cause interference, occlusion, or multipath. If such an object results in a lower signal strength of signals between the UE and the base station, the UE may select another beam, which may be associated with another base station.

The UE or the base station may send the environmental information to the server, and the server may generate enhanced beamforming information using the environmental information. For example, if the environmental information indicates nearby objects to a UE such as people, vehicles and/or buildings and a direction or directions from the UE to the nearby objects (as in the previous Example A), the enhanced beamforming information can provide information for radio beams that will arrive at the UE from directions that are different from the directions of the nearby objects (e.g., due to either direct line of sight (LOS) propagation or non-LOS with reflection from buildings), and not for radio beams that would arrive at the UE from directions that are the same as the directions of the nearby objects, due to a probability that the latter radio beams would be blocked or attenuated by the nearby objects and thereby impair reception and transmission by the UE. Faster data throughput may also be possible in some cases by using the information for radio beams provided and the direct LOS.

In some implementations, enhanced beamforming information may include one or more characteristics of radio beams between the UE and one or more base stations of the wireless communication network. Examples of the characteristics may include a direction or directions of a radio beam between the UE and a base station, length or propagation delay of a radio beam path, attenuation of a radio beam path, such that the radio beams enable improved wireless communication between the user device and the wireless communication network. These characteristics may enable selection of a radio beam between the UE and the base station that may have lower latency, higher bandwidth, higher data transmission rate, higher coverage, and/or higher reliability (e.g., signal quality) of the communication link associated with the radio beam that is formed between the UE and the base station. In some cases, the enhanced beamforming information may indicate the base station to establish a communication link with, and in some variations, may additionally indicate a list or positions of one or more other alternative base stations or access points along with their characteristics (including, e.g., a rank according to beamforming or signal quality).

In some implementations, the beamforming information may be improved based on the environmental information and/or non-environmental information. As an illustrative example, knowledge of positions of base stations, UE, reflectors, and other objects in the environment can indicate that a closer base station is nearby, or will be nearby (e.g., according to motion data). From this indication, the server may determine that the closer base station will provide better beamforming and/or higher signal quality (e.g., RSRQ, signal power, signal strength, signal reliability). In this case, the server may configure beamforming information (resulting in enhanced beamforming information) such that it indicates or instructs the UE to connect with the closer base station using a prescribed channel or radio beam that has one or more characteristics that enable improved wireless communication between the UE and the closer base station (e.g., better beamforming and/or higher signal quality). In another example, if the knowledge of the positions includes the position of a tree or other physically obstructive object between the UE and the closer base station, the server may determine that the closer base station may not provide better beamforming or signal quality. In this case, the server may configure beamforming information (which may still result in modified or enhanced beamforming information confirming the current beamforming information) such that it indicates or instructs the UE to maintain its connection with the current base station using a prescribed channel or radio beam (which may be different than those used prior to the server's configuration of the enhanced beamforming information) and/or connect with a different base station at a future time using a prescribed channel or radio beam. Here, the prescribed radio beam may have one or more characteristics that enable improved wireless communication between the UE and the closer base station (e.g., better beamforming and/or higher signal quality) by virtue of maintaining the current beam or providing instructions for a connection at a future time.

To illustrate with an example scenario, referring back to FIG. 4, the UE 105 may initially form or seek to form Rx beam 411-b with base station 420-2 based on, e.g., distance or preference or other factors. However, environmental information and/or non-environmental information (such as that obtained by the UE 105 and/or the base station 420-2 or other network devices) may indicate the presence of an object that may interfere with the Rx beam 411-b, or multiple objects that are causing multipath and signal degradation, or motion of the UE away from the base station 420-2, for instance. Based on this environmental information and/or non-environmental information, the UE 105 may select another beam, such as Rx beam 411-a with base station 420-1, despite the base station 420-1 being farther than or initially being associated with a lower signal quality, reliability, bandwidth, transmission rate (or other measurements, e.g., RSSI, RTT, RSRP, RSRQ, AoA, TOA, Rx-Tx) or higher latency than those associated with base station 420-2. However, the environmental information and/or non-environmental information may indicate that beamforming with base station 420-1 via Rx beam 411-a may result in improved data communication (e.g., improved signal quality or measurements, reliability, higher bandwidth or transmission rate, lower latency).

Similarly, for example, base station 420-2 may be producing or sending signals via Tx beam 409-b. However, the base station 420-2 may determine from environmental information (such as that obtained by the base station 420-2 and/or the UE 105 or other network devices) that one or more objects present in the local environment may be causing occlusion or multipath. Based on this environmental information, in some implementations, the base station 420-2 may select another Tx beam, such as 409-a or 409-c to mitigate the multipath or occlusion with respect to the UE 105. In some implementations, the base station 420-2 may send an instruction or request to the UE 105 (or to the server to instruct the UE 105) to switch beams to another base station such as base station 420-1.

The selected beam may possess characteristics that are more favorable for communication efficacy, e.g., higher bandwidth, signal quality, reliability, etc. Beamforming may thereby be optimized and improved using environmental information obtained by a UE or a base station (or both).

Further, in some scenarios, different UEs may be in communication with or configured for communication with different base stations. The network (e.g., a server) may use the enhanced beamforming information and/or the environmental information to determine the most suitable base station for a given UE to communicate with. The server may generate enhanced beamforming information that instructs a base station and/or a UE that the UE should be handed over to another base station that will provide better connection quality or coverage.

Moreover, the enhanced beamforming information may include or be generated based on an awareness of blockage events. More specifically, a UE or base station may predict that a blockage will happen in a future time and proactively change its beam selection, preempting the blockage. Consider an example scenario in which a UE is moving along a road, e.g., driving down road 511 from left to right of FIG. 5. Here, the UE may be in data communication with base station 515b via communication link 502b or 504b, and may be aware of the presence of trees 518a (or other obstructions) based on environmental information obtained by its sensor(s) (e.g., one or more of a camera, RF sensor, or other sensor(s)), and possibly including crowdsourced information or environmental information obtained by and received from a base station. The UE may also be aware of non-environmental information as discussed above, such as its motion and direction from left to right (or moving eastward from west of intersection 511′), or coarse location information based on GPS or GNSS sensors or other satellite measurements. In some cases, one or more base stations (including base station 515a and/or 515b) may also be aware of some or all of the above by obtaining the environmental information by its own sensor(s) or from the UE or from the server (e.g., location server 560 and/or a sensing server 561). Hence, it may be known to the UE and applicable base stations that, as the UE arrives at a region 511a, the trees 518a (and/or other obstructions) may degrade the signal quality of the communication link 502b or 504b.

Based on this environmental awareness (e.g., at least of the trees 518a) and the non-environmental awareness (e.g., at least of the UE's movement eastward), the UE (or the base station) may determine that a blockage event may occur at or around region 511a. Hence, the server may generate enhanced beamforming information indicative of one or more suitable beams between the UE and the base station 515b, one or more suitable beams between the UE and another base station such as 515a, or a combination thereof, and provide the enhanced beamforming information to the UE (and/or the applicable base stations). When the UE is at region 511a, or prior to the UE's arrival at the region 511a, the UE (and/or the base station) may select a suitable beam that has better signal quality, bandwidth, reliability, etc., thus maintaining or even improving the connectivity and communication of the UE with the network.

In certain configurations, a SUPL (Secure User Plane Location) Location Platform (SLP) may be implemented separate from and in addition (or alternate) to location server 560 and/or sensing server 561. An SLP may refer to a server or network equipment stack configured to handle tasks associated with user authentication, location requests, location-based application downloads, charging, and/or roaming. In some configurations, an SLP may be outside of a network that implements location server 560 and/or sensing server 561. In some implementations, an SLP may perform at least some functionalities of location server 560 and/or sensing server 561, such as receiving environmental information and/or non-environmental information, sending a request for such information, and/or generating and sending enhanced assistance data or enhanced beamforming information.

In other configurations, another type of dedicated server may be implemented to perform at least some functionalities of location server 560 and/or sensing server 561. Examples of such other type of server may be include a private location server or a proprietary location server, which may be neither location server 560, sensing server 561, or SLP.

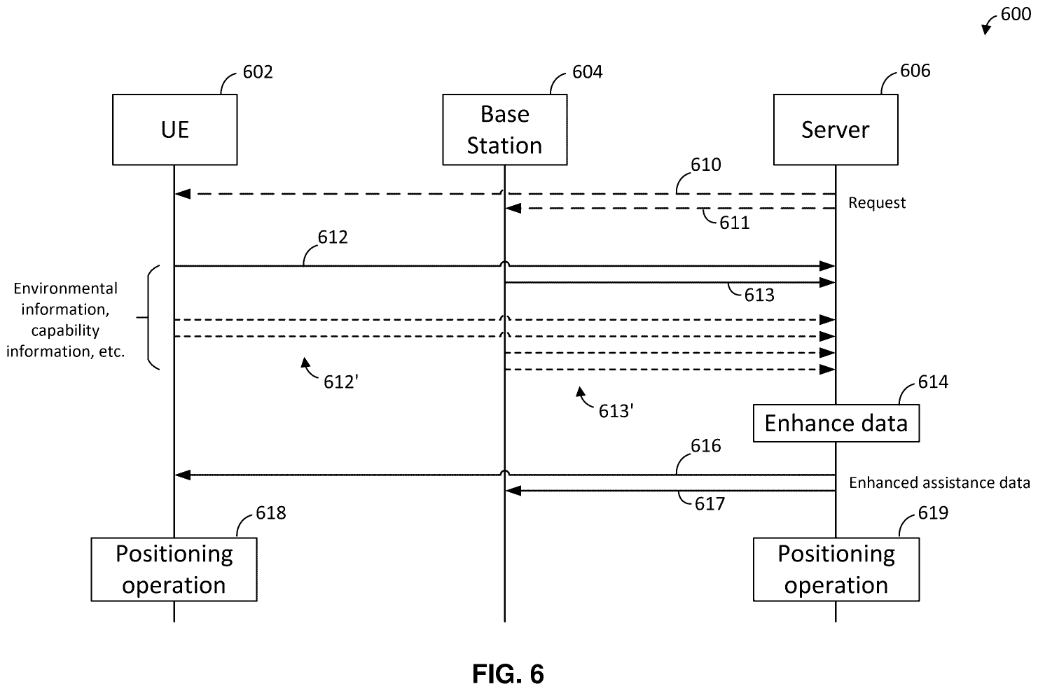

FIG. 6 is a signal flow diagram 600 depicting signals that may be exchanged among a UE 602, a base station 604, and a server 606, according to some embodiments. As discussed above, UE 602 may sense and obtain environmental information using one or more sensors. Base station 604 may also sense and obtain environmental information using one or more sensors. This environmental information along with other information (e.g., non-environmental information relating to the UE 602) may be exchanged with another network entity such as server 606 according to the following. In some embodiments, a gNB may be an example of base station 604. In some embodiments, a location server, a sensing server, or another type of dedicated server discussed above such as SLP may be an example of server 606.

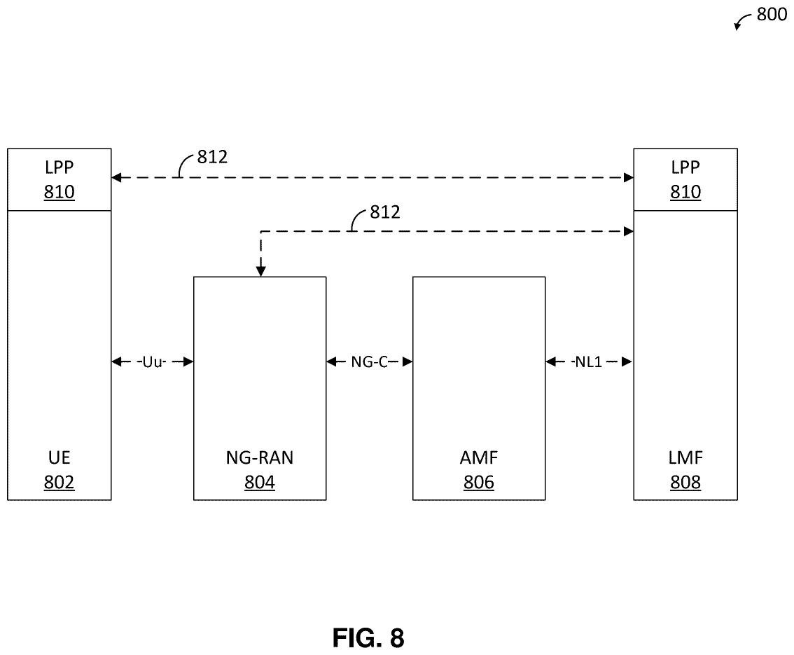

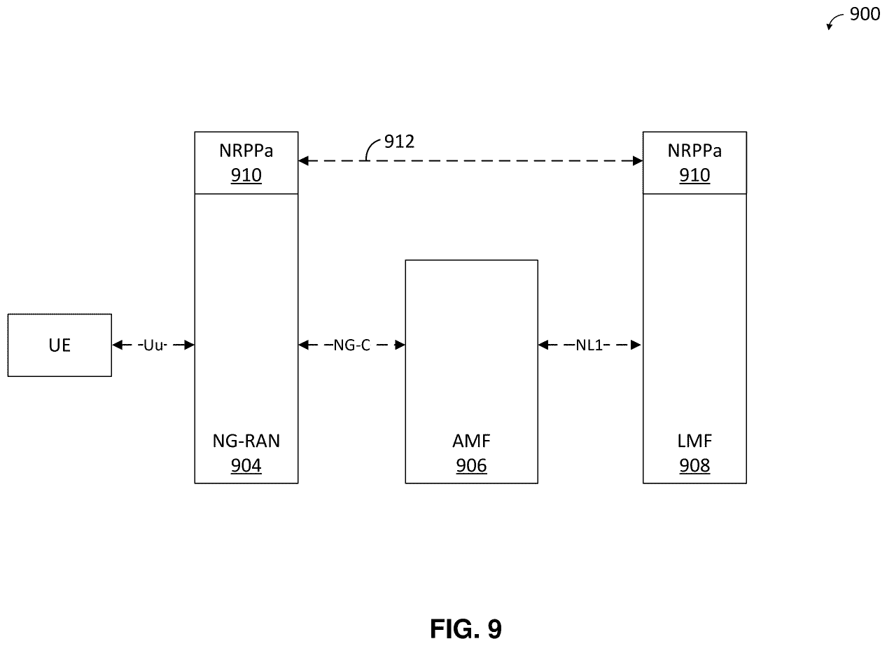

In some embodiments, at arrow 612, the UE 602 may send some or all of its sensed environmental information, capability information, sensor capability information, and/or other types of information (e.g., those summarized in Table 1) to server 606. In some scenarios, at arrow 613, the base station may send some or all of its sensed environmental information and other types of information (e.g., those summarized in Table 1) to server 606. In some configurations, arrow 612 may be performed by the UE 602 via LPP (LTE Positioning Protocol). That is, as discussed further with respect to FIG. 8, information may be transmitted or received between UE 602 and server 606 through the base station 604, but the base station 604 may not read the information. In some configurations, arrow 613 may be performed by a base station via NRPPa (NR Positioning Protocol A). LPP and NRPPa will be discussed further below with respect to FIGS. 8 and 9. In different implementations, sending the information may be periodic, performed partially to send portions of the information in each sending event 612′ (from UE 602) or 613′ (from base station 604), or performed an on-demand basis, e.g., when the server 606 requests or needs the information. For example, server 606 may send a request 610 for the information to the UE 602 and/or a request 611 for the information to the base station 604, prior to receiving the information at arrow 612. In some implementations, UE 602 may be one of multiple sensing UEs sending their respective information to the server as part of a crowdsourcing approach. Various types of information such as those listed above in Table 1 may be sent to the server 606 by each UE being crowdsourced.

Note that the UE 602 may send the information to any network entity, which may be but is not limited to a location server. For example, in other implementations, the UE may send the information to another dedicated server (e.g., a sensing server), a base station 604, an edge node, a small cell, another intermediary network device, or even another UE, some or all of which may be configured to generate enhanced assistance data, or other information such as map data (e.g., RF representation) or crowdsourced environment information (e.g., blockage events, locations of objects that the target UE is not aware of). The enhanced assistance data may be generated based on a modification of existing or previous assistance data, using the aforementioned types of information.

At block 614, the server 606 may use the received information from the UE 602 (or base station) to generate or modify assistance data, resulting in enhanced assistance data or as discussed above. For example, image data from a visual sensor (e.g., camera), RF scans from an RF sensor, infrared scans from an optical sensor (e.g., infrared sensor), and/or other types of information listed above (e.g., in Table 1) may be used to generate, refine, or update the assistance data. This enhanced assistance data may improve location accuracy and reliability of the UE (in positioning operations).

At arrow 616, the server 606 may send the enhanced assistance data to the UE 602 in some implementations, and/or to the base station at arrow 617 in some implementations.

At block 618, in some implementations, the UE 602 may (or the server 606 may cause the UE 602 to) perform a positioning operation using the enhanced assistance data. In some implementations, positioning methods may include round-trip time (RTT) measurements between UE and base stations, or cellular-based positioning (e.g., using enhanced assistance data or positioning reference signals). In some implementations, a cloud-based positioning operation at block 619 may be performed by processing signals (e.g., GNSS signals) at the server 606 using the enhanced assistance data. In some cases, both positioning operation at block 619 at the server 606 and positioning operation at block 618 at the UE 602 may be performed to determine an accurate and precise location of the UE 602.

Very accurate and precise information may be in the enhanced assistance data. This may enable a good line of sight and less environmental interference for the UE 602. Hence, sensed environmental information (and/or non-environmental information) can optimize the positioning of the UE to a very accurate and precise degree, and a very accurate and precise position of the UE 602 may be determined using the enhanced assistance data. The precision of the UE's location determined based on the enhanced assistance data may be greater than without the enhanced assistance data. For instance, location estimations made using traditional GNSS or GPS measurements or other types of positioning methods above may have a lower accuracy and precision and higher error compared to the position determined using the enhanced assistance data which may have a higher accuracy and precision and lower error compared to said traditional methods. In some scenarios, a UE may be positioned to such a high degree of precision that it may be located and tracked on the body of a person (e.g., which limb or pocket the person is carrying the UE).

Locations of some nodes and anchors (such as base stations) or other objects may be fixed and known at least to the server or other network entities. For example, the server 606 may have access to known reference data and images. This known information may include information on static entities, e.g., static blockers, anchor positions, environmental objects (e.g., trees). However, locations of some network entities such as Wi-Fi access point locations or Bluetooth receivers, objects in the environment, or the UE 602 may change over time. Positioning may become more accurate by accounting for the dynamic nature of locations of these devices or objects based on the received information from the UE(s) 602, as there may not be a central entity that maintains data on these locations.

In some implementations, the performance of the positioning operation at block 618 or 619 may be based on the enhanced assistance data in addition to other information. For example, additional environmental information and/or additional non-environmental information (collectively additional information) may be sensed or obtained using the same one or more sensors of the UE 602 (or another UE, base station 604, another base station), or it may be information known to the server 606. In some cases, this additional information may be obtained by the one or more sensors of a UE (or a base station) after receipt of the enhanced assistance data via arrow 616 and provided to the server 606 subsequently. In some cases, the additional information may be obtained before the receipt of the enhanced assistance data and provided to the server 606. In some implementations, the server 606 may generate second enhanced assistance data based on the additional information as well as the information received at arrow 612 (or 612′) or the previously generated enhanced assistance data. The additional information may be useful, e.g., in mobile situations where the position of the UE 602 or the local environment may be changed between one time to another time (e.g., as a user of the UE 602 is walking or driving). The second enhanced assistance data may be more accurate than the previously generated enhanced assistance data, especially if the position of the UE has changed since the information received at arrow 612 or the information received at arrow 612 is outdated. The second enhanced assistance data may also be precise by virtue of using more information to generate it.

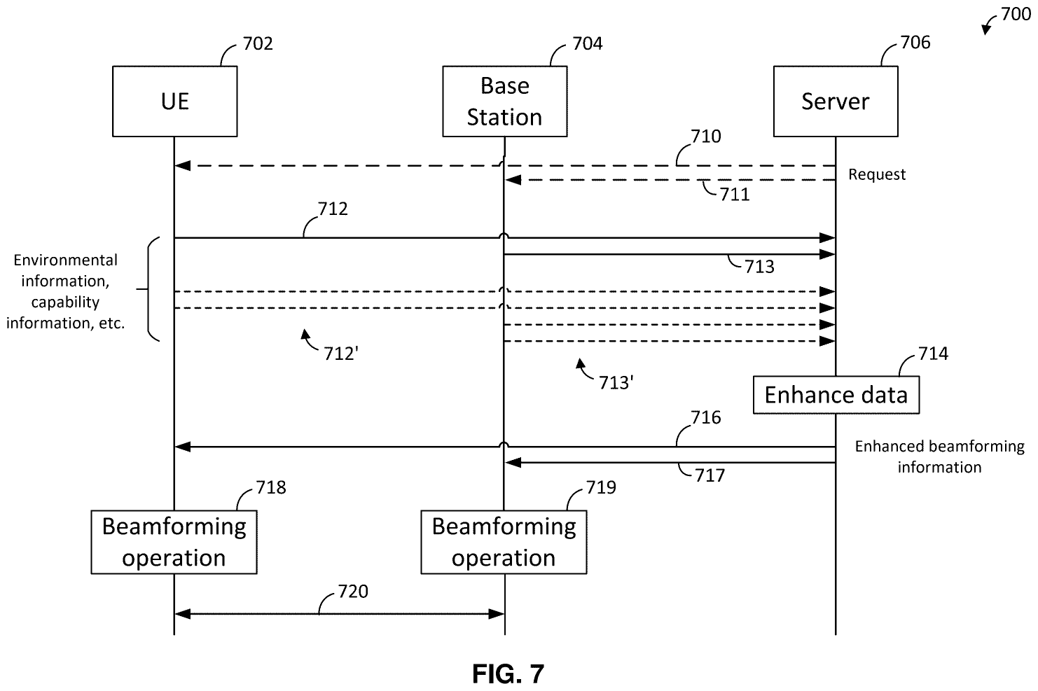

FIG. 7 is signal flow diagram 700 depicting signals that may be exchanged among a UE 702, a base station 704, and a server 706 to perform a beamforming operation for wireless communication between the UE 702 and the base station 704, according to some embodiments. Arrows and blocks 710-713 may be similar to arrows and blocks 610-613 described with respect to FIG. 6 above.

In some embodiments, at block 714, the server 706 may use the environmental information (and/or non-environmental information) received from the UE 702 and/or the base station 704 to generate or modify beamforming information with respect to or associated with the UE 702 and/or the base station 704, resulting in enhanced beamforming information. For example, image data from a visual sensor (e.g., camera), RF scans from an RF sensor, infrared scans from an optical sensor (e.g., infrared sensor), and/or other types of information listed above (e.g., in Table 1) may be used to generate, refine, or update the beamforming information. This enhanced beamforming information may improve data communication between UE 702 and base station 704, e.g., in beamforming operations and wireless communication operations between the UE 702 and the base station 704.

At arrow 716, the server 706 may send the enhanced beamforming information to the UE 702 in some implementations, and/or to the base station at arrow 717 in some implementations.

At block 718, in some implementations, the UE 702 may (or the server 706 may cause the UE 702 to) perform a beamforming operation using the enhanced beamforming information. Examples of the beamforming operation at block 718 may include selection of a beam between a UE and a base station (e.g., a Rx beam), initiation or termination of a communication link between a UE and a base station, and/or selection of a base station. In some implementations, the base station 704 may (or the server 706 may cause the base station 704 to) perform a beamforming operation using the enhanced beamforming information. Examples of the beamforming operation at block 719 may include selection of a beam between a UE and a base station (e.g., a Tx beam), initiation or termination of a communication link between a UE and a base station, and/or selection of a base station (e.g., handover to or from another base station). Further, in some implementations, at arrow 720, an enhanced communication session may be established between UE 702 and base station 704 using the enhanced beamforming information. The selected beam, formed communication link, selected base station, and/or enhanced communication session may be associated with characteristics that are more favorable for communication efficacy, e.g., higher bandwidth, signal quality, reliability, etc.

In some scenarios, there may be multiple UEs and/or multiple base stations, some of which may be proximate the UE 702 and the base station 704 (e.g., within an environment such as example environment 500). In some example scenarios, UE 702 may be in data communication with, or seek data communication with, one of base stations 420-1 and 420-2 but configured to (e.g., based on the enhanced beamforming information) select a different Rx beam or select a different base station, similar to the illustrative example scenario discussed above with respect to FIG. 5. In some other example scenarios, base station 704 may be configured to cease or initiate wireless communications with UE 702 or select a different Tx beam based on the enhanced beamforming information.

Architecturally, the above approaches can be implemented in different ways. As briefly mentioned above, in some configurations, the sensing and sending of environmental information (and/or non-environmental information) may be performed via LPP.

FIG. 8 is a block diagram 800 illustrating an example transmission of signals 812 between a UE 802 and a server via LPP 810. An LMF 808 (or a sensing server) may be an example of the server.

In the example transmission of signals 812, the UE 802 may report measurement results and/or sensed information using LPP messages to LMF 808. The LMF 808 may be implemented by a server. Intermediary entities such as a base station (part of an NG-RAN 804) and an AMF 806 may relay the LPP messages. The LMF 808 may send to the UE 802 LPP messages 812 back, such as enhanced assistance data, beamforming information, and/or map information, or portions thereof.

As noted above, communication access between a UE and a base station may be provided via a wireless interface, namely a Uu interface as shown in FIG. 8. Also as noted above, UE 802 may communicate using LPP, where messages may be transferred between the UE 802 and the LMF 808 via an AMF 806 and a serving base station that is part of an NG-RAN 804. As shown, an NG (Next Generation) user plane interface (NG-U) of the NG-RAN allows signaling between a base station and the AMF 806. The NL1 interface, between the AMF 806 and the LMF 808, is transparent to all UE-related and base station-related (e.g., gNB, ng-eNB) positioning procedures. NL1 may be used as a transport link for LPP 810 and NRPPa (discussed below). However, while information sent via LPP is read by the server (e.g., LMF 808), it is not read by the intermediary network entities NG-RAN 804 and AMF 806 and rather passes through them to the server.

FIG. 9 is a block diagram 900 illustrating an example transmission of signals 912 between a base station and a server via NRPPa 910. An LMF 908 (or a sensing server) may be an example of the server. The base station may be part of an NG-RAN 904, which may be configured for data communication with AMF 906 via NG-C, which may be configured for data communication with LMF 908 via NL1.

In the example transmission of signals 912, the base station may report measurement results and/or sensed information using NRPPa to the LMF 908. The LMF 908 may send to the base station information such as enhanced assistance data or beamforming information. In some cases, the LMF 908 may send other types of information, such as map data, to the base station.

Given FIGS. 8 and 9, any type of information may be sent to the base station of NG-RAN 904 or to the UE 802, and the information may be shared between the base station and the UE 802 (e.g., via downlink or uplink over the Uu interface).

### Methods

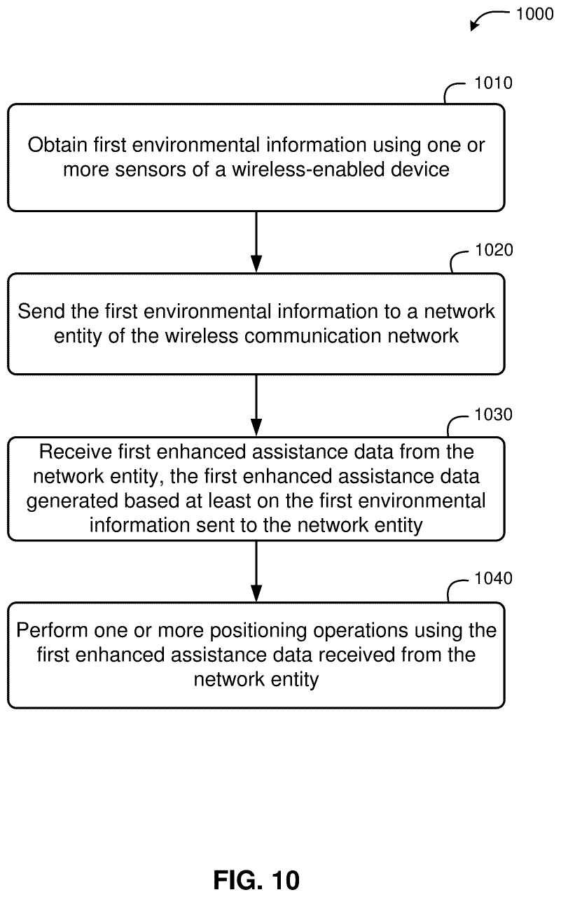

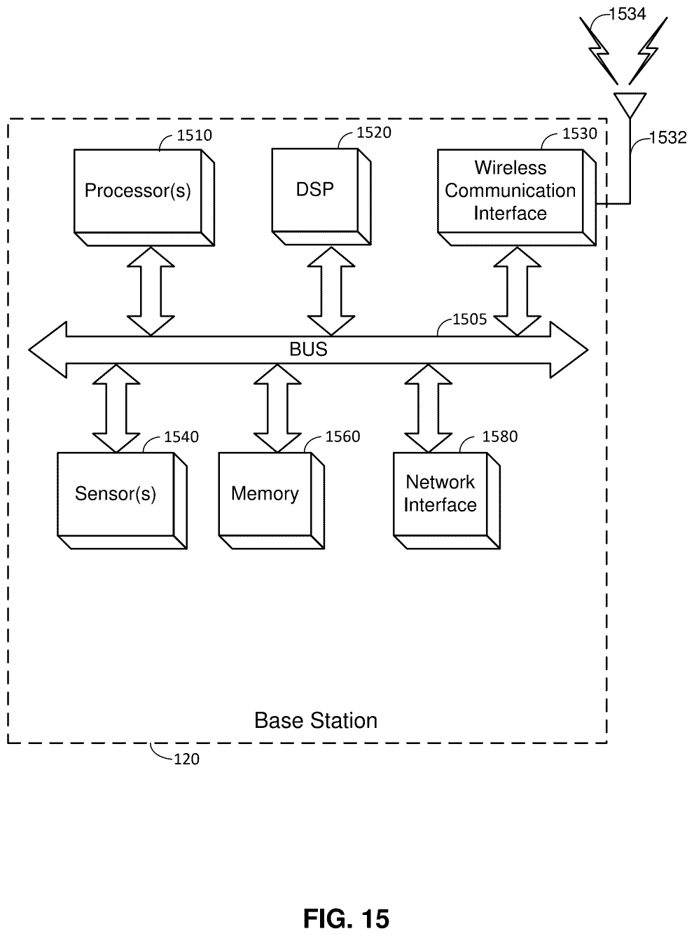

FIG. 10 is a flow diagram of a method 1000 of performing one or more positioning operations with respect to a user device in a wireless communication network, according to some embodiments. Structure for performing the functionality illustrated in one or more of the blocks shown in FIG. 10 may be performed by hardware and/or software components of a computer system or a network apparatus, e.g., a UE or a base station. Components of such computer system or network apparatus may include, for example, one or more data communication interfaces, one or more memory, one or more processors, and/or a computer-readable apparatus including a storage medium storing computer-readable and/or computer-executable instructions that are configured to, when executed by one or more processors, cause the one or more processors or the computer system or the network apparatus to perform operations represented by blocks below. Example components of a UE and a base station are illustrated in FIGS. 14 and 15, respectively, described in more detail below. It should also be noted that the operations of FIG. 10 may be performed in any suitable order, not necessarily the order depicted in FIG. 10. Further, the process shown in FIG. 10 may include additional or fewer operations than those depicted in FIG. 10.

At block 1010, a functionality of the method 1000 may include obtaining first environmental information using one or more sensors of a wireless-enabled device. In some implementations, the wireless-enabled device may be a UE or a base station (e.g., gNB, ng-eNB).

In some implementations, the first environmental information may include a type of local environment, audio data, infrared data, object information, radio frequency (RF) data, image data, or a combination thereof. An example of the RF data may be that obtained using Wi-Fi sensing. In other implementations, the first environmental information may include environmental information and data listed in Table 1.

Means for performing functionality at block 1010 may include sensor(s) 1440 or 1540, a wireless communication interface 1430 or 1530, one or more wireless communication antenna(s) 1432 or 1532, and/or other components of a UE or base station, as illustrated in FIGS. 14 and 15.

At block 1020, a functionality of the method 1000 may include sending the first environmental information to a network entity of the wireless communication network.

In some implementations, the network entity may include a location server or a sensing server of the wireless communication network. In other implementations, however, the network entity may include an SLP. In some configurations, the generation or modification of the enhanced assistance data may be performed by the location server or the sensing server.

In some implementations, the first environmental information sent to the network entity may include raw sensor data to be processed by the network entity, processed sensor data derived from the raw sensor data, configuration information obtained based on the raw sensor data, or a combination thereof.

Means for performing functionality at block 1020 may include a wireless communication interface 1430 or 1530, one or more wireless communication antenna(s) 1432 or 1532, a network interface 1580, and/or other components of a UE or base station, as illustrated in FIGS. 14 and 15.

At block 1030, a functionality of the method 1000 may include receiving first enhanced assistance data from the network entity, the first enhanced assistance data generated or modified based on the first environmental information sent to the network entity. In some embodiments, the first enhanced assistance data may be generated or modified further based on environmental information sensed using one or more sensors of one or more wireless-enabled devices other than the wireless-enabled device. In some approaches, environmental information sensed using one or more sensors of one or more wireless-enabled devices other than the wireless-enabled device may enable crowdsourcing of the environmental information, which may result in, e.g., higher accuracy and precision of the first enhanced assistance data and ultimately the one or more positioning operations.

In some embodiments, the generation of the first enhanced assistance data is performed by the location server or the sensing server.

Means for performing functionality at block 1030 may include a wireless communication interface 1430 or 1530, one or more wireless communication antenna(s) 1432 or 1532, a network interface 1580, and/or other components of a UE or base station, as illustrated in FIGS. 14 and 15.

At block 1040, a functionality of the method 1000 may include performing the one or more positioning operations using the first enhanced assistance data received from the network entity, wherein the wireless-enabled device may include the user device or a base station.

In some embodiments, the one or more positioning operations may include a positioning method to determine a location of the user device using the first enhanced assistance data. In some implementations, the positioning method to determine the location of the user device using the first enhanced assistance data may include a round-trip time (RTT) measurement, signal strength measurement, angle of arrival (AoA) measurement, angle of departure (AoD) measurement, time of arrival (TOA) measurement, time difference of arrival (TDOA) measurement, or a combination thereof, the positioning method being with respect to the user device and the base station.

In some embodiments, the one or more positioning operations may include configuration of a wireless communication channel between the user device and the base station using enhanced beamforming information generated or modified based on the first sensed environmental information sent to the network entity. A beamforming operation (e.g., selection of a beam between user device and base station) may be an example of the configuration of the wireless communication channel. Further embodiments pertaining to beamforming are discussed above and will be discussed below.

In some implementations, the wireless-enabled device may include the user device; and the sending of the first environmental information to the network entity may include the user device sending the first environmental information to a server via LPP. The user device may be a UE in some scenarios.

In some implementations, the wireless-enabled device may include the base station; and the sending of the first sensed environmental information to the network entity may include the base station sending the first sensed environmental information to a server via NRPPa.

Means for performing functionality at block 1040 may include processor(s) 1410 or 1510, a wireless communication interface 1430 or 1530, one or more wireless communication antenna(s) 1432 or 1532, and/or other components of a UE or base station, as illustrated in FIGS. 14 and 15.

In some embodiments, the method 1000 may further include obtaining second environmental information. In some implementations, the second environmental information may include environmental information sensed by the one or more sensors of the wireless-enabled device, or one or more sensors of another wireless-enabled device of the wireless communication network; and the second environmental information may include a type of local environment, audio data, infrared data, object information, radio frequency (RF) data obtained using Wi-Fi sensing, image data, or a combination thereof. In other implementations, the second environmental information may include environmental information and data listed in Table 1. In some cases, the second environmental information may include different types of information and data than the first environmental information, or it may include the same types of information and data as the first environmental information. In some cases, the second environmental information may be obtained from (e.g., obtained by one or more sensors of) the same wireless-enabled device (e.g., UE) that obtained the first environmental information, or from another UE, a base station, or another base station.

In some implementations, the second environmental information may be obtained at a time different from a time at which the first environmental information was sent to the network entity.

In some implementations, the method 1000 may further include sending the second environmental information to the network entity; and receiving second enhanced assistance data from the network entity, the second enhanced assistance data generated or modified based on the second environmental information, and having an incremental modification over the first enhanced assistance data and having at least an accuracy that is higher than an accuracy of the first enhanced assistance data. The performing of the one or more positioning operations may include using the second enhanced assistance data received from the network entity.

In some embodiments, the method 1000 may further include sending non-environmental information to the network entity, the non-environmental information including information corresponding to one or more properties of the wireless-enabled device, location information associated with the wireless-enabled device, or a combination thereof. In some situations, the location information may include rough or coarse location data. For example, this location information obtained via a non-terrestrial network (NTN) or other satellites, e.g., those used by GNSS or GPS. In some implementations, the information corresponding to the one or more properties of the wireless-enabled device may include inertia, motion, velocity, acceleration, rotation, pose, or a combination thereof measured by the wireless-enabled device. In other implementations, the one or more properties of the wireless-enabled device may include non-environmental information and data listed in Table 1. In some implementations, the enhanced assistance data may be generated or modified further based on the non-environmental information.

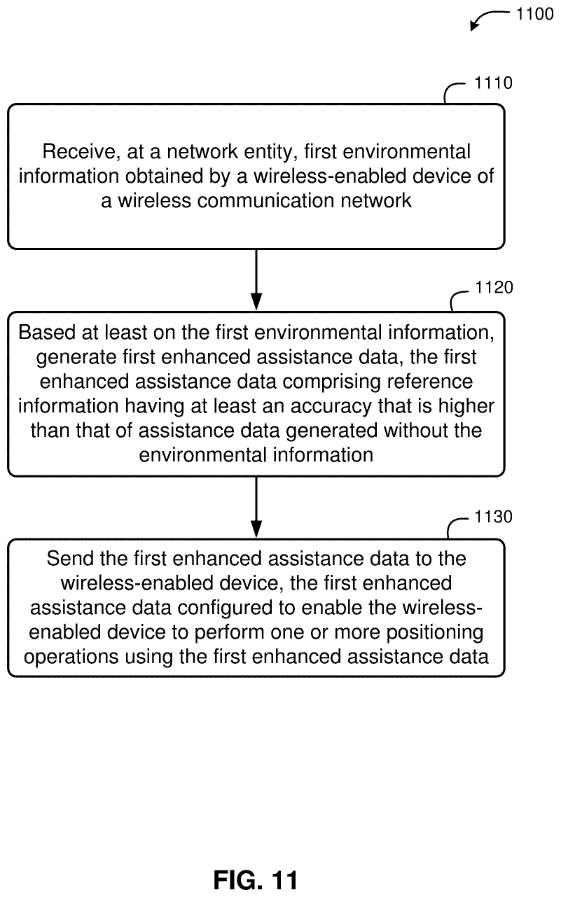

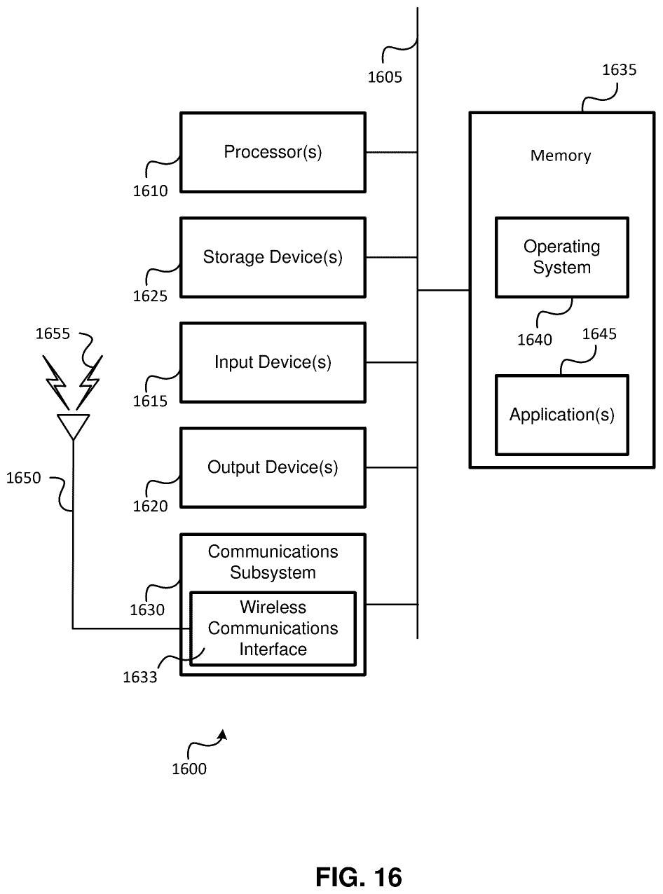

FIG. 11 is a flow diagram of a method 1100 of performing one or more positioning operations with respect to a user device in a wireless communication network, according to some embodiments. Structure for performing the functionality illustrated in one or more of the blocks shown in FIG. 11 may be performed by hardware and/or software components of a computer system or a network apparatus, e.g., a server. Components of such computer system or network apparatus may include, for example, one or more data communication interfaces, one or more memory, one or more processors, and/or a computer-readable apparatus including a storage medium storing computer-readable and/or computer-executable instructions that are configured to, when executed by one or more processors, cause the one or more processors or the computer system or the network apparatus to perform operations represented by blocks below. Example components of a server are illustrated in FIG. 16, described in more detail below. It should also be noted that the operations of FIG. 11 may be performed in any suitable order, not necessarily the order depicted in FIG. 11. Further, the process shown in FIG. 11 may include additional or fewer operations than those depicted in FIG. 11.

At block 1110, a functionality of the method 1100 may include receiving, at a network entity, first environmental information obtained by a wireless-enabled device of the wireless communication network. Depending on the implementation, the wireless-enabled device may include the user device or a base station of the wireless communication network.

In some implementations, the first environmental information sensed obtained by the wireless-enabled device may include a type of local environment, audio data, infrared data, object information, radio frequency (RF) data obtained using Wi-Fi sensing, image data, or a combination thereof. An example of the RF data may be that obtained using Wi-Fi sensing. In other implementations, the first environmental information may include environmental information and data listed in Table 1.

In some implementations, the network entity may include a location server or a sensing server of the wireless communication network. In other implementations, however, the network entity may include an SLP.

In some embodiments, the method 1100 may further include sending a request for additional environmental information to at least one of a plurality of wireless-enabled devices of the wireless communication network, the plurality of wireless-enabled devices including the wireless-enabled device and one or more wireless-enabled devices other than the wireless-enabled device. In some embodiments, the method 1100 may further include receiving the additional environmental information; generating, based on the additional environmental information, second enhanced assistance data having an incremental modification over the first enhanced assistance data and having at least an accuracy that is higher than the accuracy of the first enhanced assistance data; and sending the second enhanced assistance data to at least the wireless-enabled device. In some implementations, the generating of the first enhanced assistance data may be further based on environmental information obtained using one or more sensors of the one or more wireless-enabled devices other than the wireless-enabled device.

Means for performing functionality at block 1110 may include a communications subsystem 1630 and/or other components of a server, as illustrated in FIG. 16.

At block 1120, a functionality of the method 1100 may include, based at least on the first environmental information, generating first enhanced assistance data, the first enhanced assistance data comprising reference information having at least an accuracy that is higher than that of assistance data generated without the environmental information. Some examples of reference information within the enhanced assistance data can include information that can assist with positioning, such as reference times (e.g., transmission, arrival) associated with sending or receiving signals (e.g., PRS or other reference signals), reference positions of nodes or network devices sending or receiving signals, satellite ephemeris (including satellite position and velocity state information over a period of time), clock information, and/or clock correction information. Some examples of reference information within the enhanced assistance data can include information that can assist with measurements, such as reference times of signals sent and received, satellite identifiers, Doppler frequency information associated with satellite signal, and/or code phase.

Means for performing functionality at block 1120 may include processor(s) 1610 and/or other components of a server, as illustrated in FIG. 16.

At block 1130, a functionality of the method 1100 may include sending the first enhanced assistance data to the wireless-enabled device, the first enhanced assistance data configured to enable the wireless-enabled device to perform the one or more positioning operations using the first enhanced assistance data.

In some embodiments, the one or more positioning operations may include a positioning method to determine, by the network entity (e.g., a server), a location of the user device using the enhanced assistance data.

In some embodiments, the one or more positioning operations may include configuration of a wireless communication channel between the user device and a base station using enhanced beamforming information generated or modified based on the first sensed environmental information sent to the network entity. A beamforming operation (e.g., selection of a beam between user device and base station) may be an example of the configuration of the wireless communication channel. Further embodiments pertaining to beamforming are discussed above and will be discussed below.

In some implementations, the wireless-enabled device may include the user device; and the receiving of the first sensed environmental information may include receiving the first sensed environmental information from the user device via LPP.

In some implementations, the wireless-enabled device may include the base station; and the receiving of the first sensed environmental information may include receiving the first sensed environmental information from the base station via NRPPa.

In some embodiments, the method 1100 may further include generating a map or data structure representative of coverage and/or various perceptions of an environment, the map or data structure being generated based at least on the environmental information sensed using the one or more sensors of the one or more wireless-enabled devices other than the wireless-enabled device. In some implementations, the map or data structure may include at least one of: user-perceivable positions and/or orientation or pose of one or more signal sources within the environment, a radio frequency (RF) map or data structure representing the environment based on the one or more signal sources, information regarding one or more signals received from the wireless communication network, or any combination thereof. In some implementations, the map may include a heatmap representative of locations of one or more signal sources, one or more signal qualities associated with the one or more signal sources, one or more signal ranges associated with the one or more signal sources, or a combination thereof. In some implementations, the one or more positioning operations using the first enhanced assistance data may include using the map or data structure without initiating a session with a network node. In some implementations, the one or more positioning operations using the first enhanced assistance data may include using the map or data structure without receiving signals from a satellite.

Means for performing functionality at block 1130 may include a communications subsystem 1630 and/or other components of a server, as illustrated in FIG. 16.

In some embodiments, the method 1100 may further include second environmental information comprising environmental information obtained by the one or more sensors of the wireless-enabled device, or by one or more sensors of another wireless-enabled device of the wireless communication network. In some implementations, the second environmental information may be received at a time different from a time at which the first environmental information is received. In some implementations, the method 1100 may further include generating second enhanced assistance data different from the first enhanced assistance data based at least on the second environmental information; and sending the second enhanced assistance data to the wireless-enabled device, the second enhanced assistance data configured to enable the wireless-enabled device to perform the one or more positioning operations using the second enhanced assistance data. In some cases, the wireless-enabled device may be configured to perform the one or more positioning operations using the first enhanced assistance data and the second enhanced assistance data.

In some embodiments, the method 1100 may further include receiving non-environmental information at the network entity, the non-environmental information comprising information corresponding to one or more properties of the wireless-enabled device, location information associated with the wireless-enabled device, or a combination thereof. For example, this location information obtained via a non-terrestrial network (NTN) or other satellites, e.g., those used by GNSS or GPS. In some implementations, the one or more positioning operations using the first enhanced assistance data may be based on positioning signals associated with one or more satellites to determine a location of the user device. In some implementations, the information corresponding to the one or more properties of the wireless-enabled device may include inertia, motion, velocity, acceleration, rotation, pose, or a combination thereof measured by the wireless-enabled device. In other implementations, the one or more properties of the wireless-enabled device may include non-environmental information and data listed in Table 1. In some implementations, the first enhanced assistance data may be generated or modified further based on the non-environmental information.

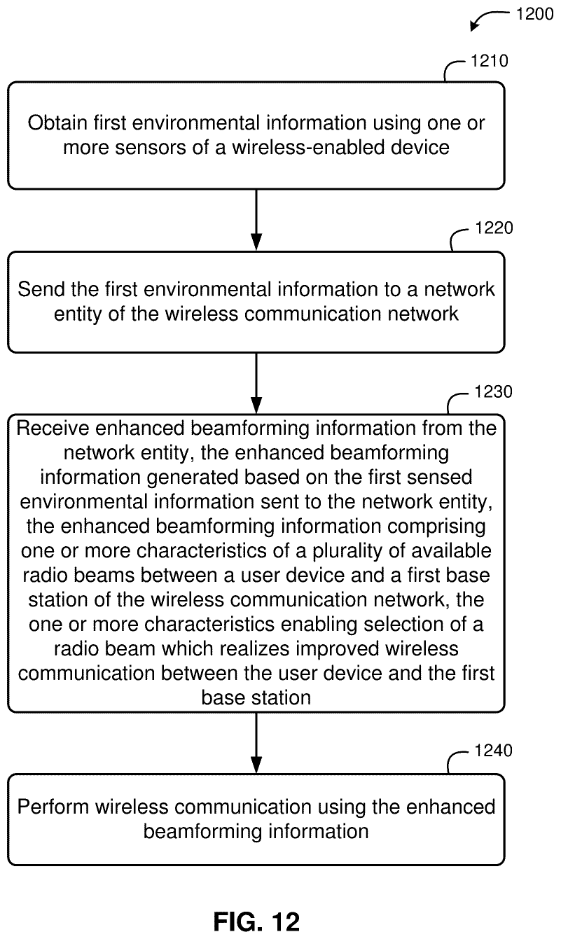

FIG. 12 is a flow diagram of a method 1200 of improving communication in a wireless communication network, according to some embodiments. Structure for performing the functionality illustrated in one or more of the blocks shown in FIG. 12 may be performed by hardware and/or software components of a computer system or a network apparatus, e.g., a UE or a base station. Components of such computer system or network apparatus may include, for example, one or more data communication interfaces, one or more memory, one or more processors, and/or a computer-readable apparatus including a storage medium storing computer-readable and/or computer-executable instructions that are configured to, when executed by one or more processors, cause the one or more processors or the computer system or the network apparatus to perform operations represented by blocks below. Example components of a UE and a base station are illustrated in FIGS. 14 and 15, respectively, described in more detail below. It should also be noted that the operations of FIG. 12 may be performed in any suitable order, not necessarily the order depicted in FIG. 12. Further, the process shown in FIG. 12 may include additional or fewer operations than those depicted in FIG. 12.

At block 1210, a functionality of the method 1200 may include obtaining first environmental information using one or more sensors of a wireless-enabled device. Depending on implementation, the wireless-enabled device may include a first base station or the user device.

Means for performing functionality at block 1210 may include sensor(s) 1440 or 1540, a wireless communication interface 1430 or 1530, one or more wireless communication antenna(s) 1432 or 1532, and/or other components of a UE or base station, as illustrated in FIGS. 14 and 15.

At block 1220, a functionality of the method 1200 may include sending the first environmental information to a network entity of the wireless communication network.

Means for performing functionality at block 1220 may include a wireless communication interface 1430 or 1530, one or more wireless communication antenna(s) 1432 or 1532, a network interface 1580, and/or other components of a UE or base station, as illustrated in FIGS. 14 and 15.

At block 1230, a functionality of the method 1200 may include receiving enhanced beamforming information from the network entity, the enhanced beamforming information generated based on the first sensed environmental information sent to the network entity, the enhanced beamforming information comprising one or more characteristics of a plurality of available radio beams between a user device and a first base station of the wireless communication network. The one or more characteristics may enable selection of a radio beam which realizes improved wireless communication between the user device and the first base station. The wireless communication may be improved as compared to wireless communication between the user device and the first base station without using the enhanced beamforming information. In some implementations, the one or more characteristics may include a direction of a radio beam between the user device and the first base station, a length of a radio beam path, a propagation delay of the radio beam path, an attenuation of the radio beam path, or a combination thereof.

Means for performing functionality at block 1230 may include a wireless communication interface 1430 or 1530, one or more wireless communication antenna(s) 1432 or 1532, a network interface 1580, and/or other components of a UE or base station, as illustrated in FIGS. 14 and 15.

At block 1240, a functionality of the method 1200 may include performing wireless communication using the enhanced beamforming information. In some embodiments, the performing of the wireless communication using the enhanced beamforming information may include selecting the radio beam from the plurality of available radio beams between the user device and the first base station based at least in part on the one or more characteristics of the plurality of available radio beams between the user device and the first base station, the selected radio beam resulting in the improved wireless communication between the user device and the first base station as compared to wireless communication between the user device and the first base station without using the enhanced beamforming information.

In some embodiments, performing the wireless communication using enhanced beamforming information may include performing a beam selection to (i) provide a connection between the first base station and the user device having a higher signal quality, strength, power, or reliability than a beam selection without the enhanced beamforming information, (ii) provide a connection between the first base station and the user device having a higher signal coverage than the beam selection without the enhanced beamforming information, (iii) mitigate interference from a physical occlusion in an area associated with the user device, or a combination thereof. Faster data throughput may also be possible in some cases as a result of the beam selection and the direct LOS as mentioned above.

In some embodiments, the performing of the wireless communication using the enhanced beamforming information may include adjusting a beamforming configuration of the wireless-enabled device using the enhanced beamforming information.

In some configurations, the wireless-enabled device may include the first base station, and the improved wireless communication may be performed via a communication link associated with a radio beam and between the first base station and the user device. In some cases, the improved wireless communication between the user device and the first base station may be characterized by lower latency, higher bandwidth, higher data transmission rate, higher coverage, higher reliability, higher signal quality, or a combination thereof, of the communication link associated with the radio beam. In some approaches, the enhanced beamforming information may include an instruction to the wireless-enabled device to, based on the first environmental information, switch to the communication link between the first base station and the user device from another communication link between the user device and a second base station.

In some configurations, the wireless-enabled device may include the user device, and the wireless communication may be performed via a communication link associated with the radio beam and between the first base station and the user device.

Means for performing functionality at block 1240 may include processor(s) 1410 or 1510, a wireless communication interface 1430 or 1530, one or more wireless communication antenna(s) 1432 or 1532, and/or other components of a UE or base station, as illustrated in FIGS. 14 and 15.

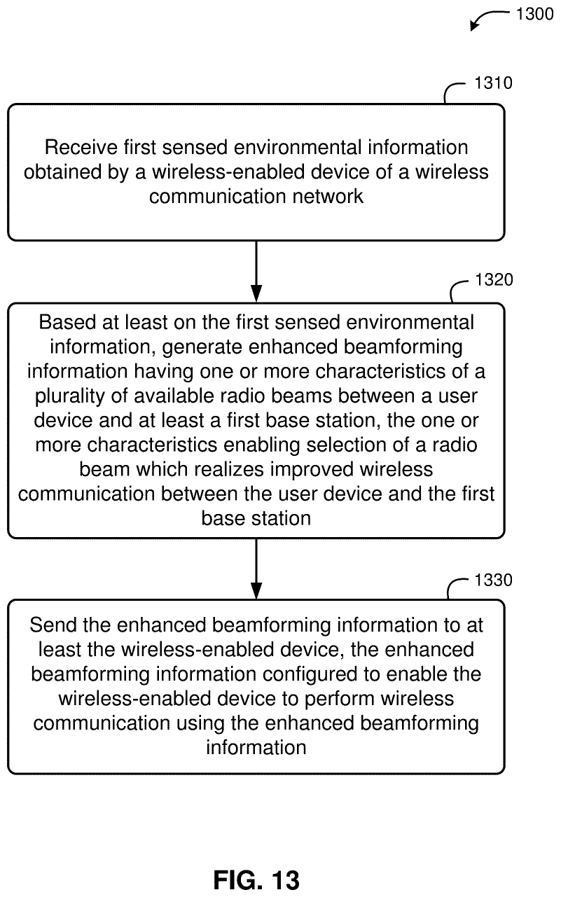

FIG. 13 is a flow diagram of a method 1300 of improving communication in a wireless communication network, according to some embodiments. Structure for performing the functionality illustrated in one or more of the blocks shown in FIG. 13 may be performed by hardware and/or software components of a computer system or a network apparatus, e.g., a server. Components of such computer system or network apparatus may include, for example, one or more data communication interfaces, one or more memory, one or more processors, and/or a computer-readable apparatus including a storage medium storing computer-readable and/or computer-executable instructions that are configured to, when executed by one or more processors, cause the one or more processors or the computer system or the network apparatus to perform operations represented by blocks below. Example components of a server are illustrated in FIG. 16, described in more detail below. It should also be noted that the operations of FIG. 13 may be performed in any suitable order, not necessarily the order depicted in FIG. 13. Further, the process shown in FIG. 13 may include additional or fewer operations than those depicted in FIG. 13.

At block 1310, a functionality of the method 1300 may include receiving first sensed environmental information obtained by a wireless-enabled device of the wireless communication network. According to implementations, the wireless-enabled device may include a user device or a first base station of the wireless communication network. In some implementations, the wireless-enabled device may include the first base station, and the wireless communication may be performed via a communication link between the first base station and the user device. In some implementations, the wireless-enabled device may include the user device, and the wireless communication may be performed via a communication link between the first base station and the user device.

Means for performing functionality at block 1310 may include a communications subsystem 1630 and/or other components of a server, as illustrated in FIG. 16.

At block 1320, a functionality of the method 1300 may include, based at least on the first sensed environmental information, generating enhanced beamforming information having one or more characteristics of a plurality of available radio beams between the user device and at least the first base station of the wireless communication network. The one or more characteristics may enable selection of a radio beam which realizes improved wireless communication between the user device and the first base station. The wireless communication may be improved as compared to wireless communication between the user device and the first base station without using the enhanced beamforming information. In some implementations, the enhanced beamforming information may include an instruction to the wireless-enabled device to, based on the first sensed environmental information, switch to the communication link between the first base station and the user device from another communication link between the user device and a second base station.

Means for performing functionality at block 1320 may include processor(s) 1610 and/or other components of a server, as illustrated in FIG. 16.

At block 1330, a functionality of the method 1300 may include sending the enhanced beamforming information to at least the wireless-enabled device, the enhanced beamforming information configured to enable the wireless-enabled device to perform wireless communication using the enhanced beamforming information. In some implementations, the improved wireless communication using the enhanced beamforming information may include an adjustment in beamforming configuration of the user device, beamforming configuration of the network apparatus, or both, to perform wireless communication between the wireless device and the network apparatus. In some implementations, the improved wireless communication using the enhanced beamforming information may include a beam selection to (i) provide a connection between the first base station and the user device having a higher signal quality, strength, power, or reliability than a beam selection without the enhanced beamforming information, (ii) provide a connection between the first base station and the user device having a higher signal coverage than the beam selection without the enhanced beamforming information, (iii) mitigate interference from a physical occlusion in an area associated with the user device, or a combination thereof. Faster data throughput may also be possible in some cases as a result of the beam selection and the direct LOS as mentioned above.

Means for performing functionality at block 1330 may include a communications subsystem 1630 and/or other components of a server, as illustrated in FIG. 16.

### Apparatus

FIG. 14 is a block diagram of an embodiment of a UE 105, which can be utilized as described herein above (e.g., in association with FIGS. 1-9). For example, the UE 105 can perform one or more of the functions of the method shown in FIGS. 10 and 12. It should be noted that FIG. 14 is meant only to provide a generalized illustration of various components, any or all of which may be utilized as appropriate. It can be noted that, in some instances, components illustrated by FIG. 14 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 14.

The UE 105 is shown comprising hardware elements that can be electrically coupled via a bus 1405 (or may otherwise be in communication, as appropriate). The hardware elements may include a processor(s) 1410 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1410 may comprise one or more processing units, which may be housed in a single integrated circuit (IC) or multiple ICs. As shown in FIG. 14, some embodiments may have a separate DSP 1420, depending on desired functionality. Location determination and/or other determinations based on wireless communication may be provided in the processor(s) 1410 and/or wireless communication interface 1430 (discussed below). The UE 105 also can include one or more input devices 1470, which can include without limitation one or more keyboards, touch screens, touch pads, microphones, buttons, dials, switches, and/or the like; and one or more output devices 1415, which can include without limitation one or more displays (e.g., touch screens), light emitting diodes (LEDs), speakers, and/or the like.

The UE 105 may also include a wireless communication interface 1430, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 1430 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1432 that send and/or receive wireless signals 1434. According to some embodiments, the wireless communication antenna(s) 1432 may comprise a plurality of discrete antennas, antenna arrays, or any combination thereof. The antenna(s) 1432 may be capable of transmitting and receiving wireless signals using beams (e.g., Tx beams and Rx beams). Beam formation may be performed using digital and/or analog beam formation techniques, with respective digital and/or analog circuitry. The wireless communication interface 1430 may include such circuitry.

Further, in some embodiments, the UE 105 may also include may implement an RF sensing system 1435, which may correspond to the RF sensing system 305 described above with respect to FIG. 3, and/or include the hardware and/or software elements described with respect to FIG. 3. Some or all of the RF sensing system 1435 may be implemented with the wireless communication interface 1430. Alternative embodiments may implement some or all of the RF sensing system 1435 separate from the wireless communication interface 1430 (e.g., in cases where RF sensing may utilize different frequencies and/or different hardware/software components than the wireless communication interface 1430).

Depending on desired functionality, the wireless communication interface 1430 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 1440. Sensor(s) 1440 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain environmental information from the surroundings of the UE 105, position-related measurements and/or other information.

Embodiments of the UE 105 may also include a Global Navigation Satellite System (GNSS) receiver 1480 capable of receiving signals 1484 from one or more GNSS satellites using an antenna 1482 (which could be the same as antenna 1432). Positioning based on GNSS signal measurement can be utilized to complement and/or incorporate the techniques described herein. The GNSS receiver 1480 can extract a position of the UE 105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1480 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1480 is illustrated in FIG. 14 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1410, DSP 1420, and/or a processor within the wireless communication interface 1430 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1410 or DSP 1420.

The UE 105 may further include and/or be in communication with a memory 1460. The memory 1460 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1460 of the UE 105 also can comprise software elements (not shown in FIG. 14), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1460 that are executable by the UE 105 (and/or processor(s) 1410 or DSP 1420 within UE 105). In some embodiments, then, such code and/or instructions can be used to configure and/or adapt a general-purpose computer (or other device) to perform one or more operations in accordance with the described methods.

FIG. 15 is a block diagram of an embodiment of a base station 120, which can be utilized as described herein above (e.g., in association with FIGS. 1-9). For example, the base station 120 can perform one or more of the functions of the method shown in FIGS. 10 and 12. It should be noted that FIG. 15 is meant only to provide a generalized illustration of various components, any or all of which may be utilized as appropriate. In some embodiments, the base station 120 may correspond to a gNB, an ng-eNB, and/or (more generally) a TRP.

The base station 120 is shown comprising hardware elements that can be electrically coupled via a bus 1505 (or may otherwise be in communication, as appropriate). The hardware elements may include a processor(s) 1510 which can include without limitation one or more general-purpose processors, one or more special-purpose processors (such as DSP chips, graphics acceleration processors, ASICs, and/or the like), and/or other processing structure or means. As shown in FIG. 15, some embodiments may have a separate DSP 1520, depending on desired functionality. Location determination and/or other determinations based on wireless communication may be provided in the processor(s) 1510 and/or wireless communication interface 1530 (discussed below), according to some embodiments. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 might also include a wireless communication interface 1530, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 1530 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1532 that send and/or receive wireless signals 1534.

The base station 120 may also include a network interface 1580, which can include support of wireline communication technologies. The network interface 1580 may include a modem, network card, chipset, and/or the like. The network interface 1580 may include one or more input and/or output communication interfaces to permit data to be exchanged with a network, communication network servers, computer systems, and/or any other electronic devices described herein.

The base station 120 can further include sensor(s) 1540. Sensor(s) 1540 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain environmental information from the surroundings of the base station 120, position-related measurements and/or other information.

In many embodiments, the base station 120 may further comprise a memory 1560. The memory 1560 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1560 of the base station 120 also may comprise software elements (not shown in FIG. 15), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1560 that are executable by the base station 120 (and/or processor(s) 1510 or DSP 1520 within base station 120). In some embodiments, then, such code and/or instructions can be used to configure and/or adapt a general-purpose computer (or other device) to perform one or more operations in accordance with the described methods.

FIG. 16 is a block diagram of an embodiment of a computer system 1600, which may be used, in whole or in part, to provide the functions of one or more network components as described in the embodiments herein (e.g., location server 160 or sensing server 161 of FIG. 1 or other dedicated servers such as an SLP). For example, the computer system 1600 can perform one or more of the functions of the method shown in FIGS. 11 and 13. It should be noted that FIG. 16 is meant only to provide a generalized illustration of various components, any or all of which may be utilized as appropriate. FIG. 16, therefore, broadly illustrates how individual system elements may be implemented in a relatively separated or relatively more integrated manner. In addition, it can be noted that components illustrated by FIG. 16 can be localized to a single device and/or distributed among various networked devices, which may be disposed at different geographical locations.

The computer system 1600 is shown comprising hardware elements that can be electrically coupled via a bus 1605 (or may otherwise be in communication, as appropriate). The hardware elements may include processor(s) 1610, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1600 also may comprise one or more input devices 1615, which may comprise without limitation a mouse, a keyboard, a camera, a microphone, and/or the like; and one or more output devices 1620, which may comprise without limitation a display device, a printer, and/or the like.

The computer system 1600 may further include (and/or be in communication with) one or more non-transitory storage devices 1625, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1600 may also include a communications subsystem 1630, which may comprise wireless communication technologies managed and controlled by a wireless communication interface 1633, as well as wired technologies (such as Ethernet, coaxial communications, universal serial bus (USB), and the like). The wireless communication interface 1633 may comprise one or more wireless transceivers that may send and receive wireless signals 1655 (e.g., signals according to 5G NR or LTE) via wireless antenna(s) 1650. Thus the communications subsystem 1630 may comprise a modem, a network card (wireless or wired), an infrared communication device, a wireless communication device, and/or a chipset, and/or the like, which may enable the computer system 1600 to communicate on any or all of the communication networks described herein to any device on the respective network, including a User Equipment (UE), base stations and/or other TRPs, and/or any other electronic devices described herein. Hence, the communications subsystem 1630 may be used to receive and send data as described in the embodiments herein.

In many embodiments, the computer system 1600 will further comprise a working memory 1635, which may comprise a RAM or ROM device, as described above. Software elements, shown as being located within the working memory 1635, may comprise an operating system 1640, device drivers, executable libraries, and/or other code, such as one or more applications 1645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1625 described above. In some cases, the storage medium might be incorporated within a computer system, such as computer system 1600. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1600 and/or might take the form of source and/or installable code, which, upon compilation and/or installation on the computer system 1600 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of performing one or more positioning operations with respect to a user device in a wireless communication network, the method comprising: obtaining first environmental information using one or more sensors of a wireless-enabled device; sending the first environmental information to a network entity of the wireless communication network; receiving first enhanced assistance data from the network entity, the first enhanced assistance data generated based at least on the first environmental information sent to the network entity; and performing the one or more positioning operations using the first enhanced assistance data received from the network entity, wherein the wireless-enabled device comprises the user device or a base station.
Clause 2. The method of clause 1, wherein the first environmental information comprises a type of local environment, audio data, infrared data, object information, radio frequency (RF) data, image data, or a combination thereof.
Clause 3. The method of clause 1, wherein the first environmental information sent to the network entity comprises raw sensor data to be processed by the network entity, processed sensor data derived from the raw sensor data, configuration information obtained based on the raw sensor data, or a combination thereof.
Clause 4. The method of clause 1, further comprising obtaining second environmental information; wherein: the second environmental information comprises environmental information sensed by the one or more sensors of the wireless-enabled device, or one or more sensors of another wireless-enabled device of the wireless communication network; and the second environmental information comprises a type of local environment, audio data, infrared data, object information, radio frequency (RF) data, image data, or a combination thereof.
Clause 5. The method of clause 4, wherein the second environmental information is obtained at a time different from a time at which the first environmental information was sent to the network entity.
Clause 6. The method of clause 4, further comprising: sending the second environmental information to the network entity; and receiving second enhanced assistance data from the network entity, the second enhanced assistance data generated based on the second environmental information, and having an incremental modification over the first enhanced assistance data and having at least an accuracy that is higher than an accuracy of the first enhanced assistance data; wherein the performing of the one or more positioning operations comprises using the second enhanced assistance data received from the network entity.
Clause 7. The method of clause 1, further comprising sending non-environmental information to the network entity, the non-environmental information comprising information corresponding to one or more properties of the wireless-enabled device, location information associated with the wireless-enabled device, or a combination thereof.
Clause 8. The method of clause 7, wherein the information corresponding to the one or more properties of the wireless-enabled device comprises inertia, motion, velocity, acceleration, rotation, pose, or a combination thereof measured by the wireless-enabled device.
Clause 9. The method of clause 7, wherein the first enhanced assistance data is further based on the non-environmental information.
Clause 10. The method of clause 1, wherein the first enhanced assistance data is further based on environmental information sensed using one or more sensors of one or more wireless-enabled devices other than the wireless-enabled device.
Clause 11. The method of clause 1, wherein the network entity comprises a location server or a sensing server of the wireless communication network.
Clause 12. The method of clause 11, wherein the generation of the first enhanced assistance data is performed by the location server or the sensing server.
Clause 13. The method of clause 1, wherein the one or more positioning operations comprise a positioning method to determine a location of the user device using the first enhanced assistance data.
Clause 14. The method of clause 13, wherein the positioning method to determine the location of the user device using the first enhanced assistance data comprises a round-trip time (RTT) measurement, a signal strength measurement, an angle of arrival (AoA) measurement, an angle of departure (AoD) measurement, a time of arrival (TOA) measurement, a time difference of arrival (TDOA) measurement, or a combination thereof, the positioning method being with respect to the user device and the base station.
Clause 15. The method of clause 1, wherein the one or more positioning operations comprise configuration of a wireless communication channel between the user device and the base station using enhanced beamforming information generated based on the first environmental information sent to the network entity.
Clause 16. The method of clause 1, wherein: the wireless-enabled device comprises the user device; and the sending of the first environmental information to the network entity comprises the user device sending the first environmental information to a server via LPP (LTE Positioning Protocol).
Clause 17. The method of clause 1, wherein: the wireless-enabled device comprises the base station; and the sending of the first environmental information to the network entity comprises the base station sending the first environmental information to a server via NRPPa (NR positioning protocol A).
Clause 18. A user device comprising: one or more transceivers configured to perform data communication in a wireless communication network; one or more memory; one or more processors communicatively coupled to the one or more transceivers and the one or more memory, the one or more processors configured to: obtain first environmental information using one or more sensors of a wireless-enabled device; sending the first environmental information to a network entity of the wireless communication network; receive first enhanced assistance data from the network entity, the first enhanced assistance data generated based at least on the first environmental information sent to the network entity; and perform one or more positioning operations using the first enhanced assistance data received from the network entity, wherein the wireless-enabled device comprises the user device or a base station.
Clause 19. The user device of clause 18, wherein the first environmental information comprises a type of local environment, audio data, infrared data, object information, radio frequency (RF) data, image data, or a combination thereof.
Clause 20. The user device of clause 18, wherein the first environmental information sent to the network entity comprises raw sensor data to be processed by the network entity, processed sensor data derived from the raw sensor data, configuration information obtained based on the raw sensor data, or a combination thereof.
Clause 21. The user device of clause 18, wherein the one or more processors are further configured to obtain second environmental information; wherein: the second environmental information comprises environmental information sensed by the one or more sensors of the wireless-enabled device, or one or more sensors of another wireless-enabled device of the wireless communication network; and the second environmental information comprises a type of local environment, audio data, infrared data, object information, radio frequency (RF) data, image data, or a combination thereof.
   Qualcomm Ref. No. 2309162-84.
Clause 22. The user device of clause 21, wherein the second environmental information is obtained at a time different from a time at which the first environmental information was sent to the network entity.
Clause 23. The user device of clause 21, wherein the one or more processors are further configured to: send the second environmental information to the network entity; and receive second enhanced assistance data from the network entity, the second enhanced assistance data generated based on the second environmental information, having an incremental modification over the first enhanced assistance data and having at least an accuracy that is higher than an accuracy of the first enhanced assistance data; wherein the performing of the one or more positioning operations comprises using the second enhanced assistance data received from the network entity.
Clause 24. The user device of clause 18, wherein the one or more processors are further configured to: send non-environmental information to the network entity, the non-environmental information comprising information corresponding to one or more properties of the wireless-enabled device, location information associated with the wireless-enabled device, or a combination thereof.
Clause 25. The user device of clause 24, wherein the information corresponding to the one or more properties of the wireless-enabled device comprises inertia, motion, velocity, acceleration, rotation, pose, or a combination thereof measured by the wireless-enabled device.
Clause 26. The user device of clause 24, wherein the first enhanced assistance data is further based on the non-environmental information.
Clause 27. The user device of clause 18, wherein the first enhanced assistance data is further based on environmental information sensed using one or more sensors of one or more wireless-enabled devices other than the wireless-enabled device.
Clause 28. The user device of clause 18, wherein the network entity comprises a location server or a sensing server of the wireless communication network.
Clause 29. The user device of clause 28, wherein the generation of the first enhanced assistance data is performed by the location server or the sensing server.
Clause 30. The user device of clause 18, wherein the one or more positioning operations comprise a positioning method to determine a location of the user device using the first enhanced assistance data.
Clause 31. The user device of clause 30, wherein the positioning method to determine the location of the user device using the first enhanced assistance data comprises a round-trip time (RTT) measurement between the user device and the base station, signal strength measurement, angle of arrival (AoA), angle of departure (AoD), time of arrival (TOA) measurement, time difference of arrival (TDOA) measurement, or a combination thereof, the positioning method being with respect to the user device and the base station.
Clause 32. The user device of clause 18, wherein the one or more positioning operations comprise configuration of a wireless communication channel between the user device and the base station using enhanced beamforming information generated based on the first environmental information sent to the network entity.
Clause 33. The user device of clause 18, wherein: the wireless-enabled device comprises the user device; and the sending of the first environmental information to the network entity comprises the user device sending the first environmental information to a server via LPP (LTE Positioning Protocol).
Clause 34. The user device of clause 18, wherein: the wireless-enabled device comprises the base station; and the sending of the first environmental information to the network entity comprises the base station sending the first environmental information to a server via NRPPa (NR positioning protocol A).
Clause 35. A method of performing one or more positioning operations with respect to a user device in a wireless communication network, the method comprising: receiving, at a network entity, first environmental information obtained by a wireless-enabled device of the wireless communication network; based at least on the first environmental information, generating first enhanced assistance data, the first enhanced assistance data comprising reference information having at least an accuracy that is higher than that of assistance data generated without the environmental information; and sending the first enhanced assistance data to the wireless-enabled device, the first enhanced assistance data configured to enable the wireless-enabled device to perform the one or more positioning operations using the first enhanced assistance data.
Clause 36. The method of clause 35, wherein the first environmental information obtained by the wireless-enabled device comprises a type of local environment, audio data, infrared data, object information, radio frequency (RF) data, image data, or a combination thereof.
Clause 37. The method of clause 35, wherein the network entity comprises a location server or a sensing server of the wireless communication network.
Clause 38. The method of clause 35, further comprising sending a request for additional environmental information to at least one of a plurality of wireless-enabled devices of the wireless communication network, the plurality of wireless-enabled devices comprising the wireless-enabled device and one or more wireless-enabled devices other than the wireless-enabled device.
Clause 39. The method of clause 38, further comprising: receiving the additional environmental information; generating, based on the additional environmental information, second enhanced assistance data having an incremental modification over the first enhanced assistance data and having at least an accuracy that is higher than the accuracy of the first enhanced assistance data; and sending the second enhanced assistance data to at least the wireless-enabled device.
Clause 40. The method of clause 35, wherein the generating of the first enhanced assistance data is further based on environmental information obtained using one or more sensors of one or more wireless-enabled devices other than the wireless-enabled device.
Clause 41. The method of clause 40, further comprising receiving second environmental information comprising environmental information obtained by the one or more sensors of the wireless-enabled device, or by one or more sensors of another wireless-enabled device of the wireless communication network; wherein the second environmental information is received at a time different from a time at which the first environmental information is received.
Clause 42. The method of clause 41, further comprising: generating second enhanced assistance data different from the first enhanced assistance data based at least on the second environmental information; and sending the second enhanced assistance data to the wireless-enabled device, the second enhanced assistance data configured to enable the wireless-enabled device to perform the one or more positioning operations using the second enhanced assistance data.
Clause 43. The method of clause 40, further comprising generating a map or data structure representative of coverage and/or various perceptions of an environment, the map or data structure being generated based at least on the environmental information sensed using the one or more sensors of the one or more wireless-enabled devices other than the wireless-enabled device.
Clause 44. The method of clause 43, wherein the map or data structure comprises at least one of: user-perceivable positions and/or orientation or pose of one or more signal sources within the environment, a radio frequency (RF) map or data structure representing the environment based on the one or more signal sources, information regarding one or more signals received from the wireless communication network, or any combination thereof.
Clause 45. The method of clause 43, wherein the map comprises a heatmap representative of locations of one or more signal sources, one or more signal qualities associated with the one or more signal sources, one or more signal ranges associated with the one or more signal sources, or a combination thereof.
Clause 46. The method of clause 43, wherein the one or more positioning operations using the first enhanced assistance data comprise using the map or data structure without initiating a session with a network node.
Clause 47. The method of clause 43, wherein the one or more positioning operations using the first enhanced assistance data comprise using the map or data structure without receiving signals from a satellite.
Clause 48. The method of clause 35, further comprising receiving non-environmental information at the network entity, the non-environmental information comprising information corresponding to one or more properties of the wireless-enabled device, location information associated with the wireless-enabled device, or a combination thereof.
Clause 49. The method of clause 43, wherein the information corresponding to the one or more properties of the wireless-enabled device comprises inertia, motion, velocity, acceleration, rotation, pose, or a combination thereof measured by the wireless-enabled device.
Clause 50. The method of clause 43, wherein the first enhanced assistance data is further based on the non-environmental information.
Clause 51. The method of clause 43, wherein the one or more positioning operations using the first enhanced assistance data are based on positioning signals associated with one or more satellites to determine a location of the user device.
Clause 52. The method of clause 35, wherein the one or more positioning operations comprise a positioning method to determine, by the network entity, a location of the user device using the first enhanced assistance data.
Clause 53. The method of clause 35, wherein the one or more positioning operations comprise configuration of a wireless communication channel between the user device and a base station using enhanced beamforming information generated based on the first environmental information sent to the network entity.
Clause 54. The method of clause 35, wherein: the wireless-enabled device comprises a user device; and the receiving of the first environmental information comprises receiving the first environmental information from the user device via LPP (LTE Positioning Protocol).
Clause 55. The method of clause 35, wherein: the wireless-enabled device comprises a base station; and the receiving of the first environmental information comprises receiving the first environmental information from the base station via NRPPa (NR positioning protocol A).
Clause 56. A network apparatus comprising: one or more data communication interfaces configured to perform data communication with at least a user device in a wireless communication network; one or more memory; one or more processors communicatively coupled to the one or more data communication interfaces and the one or more memory, the one or more processors configured to: receive, at the network apparatus, first environmental information obtained by a wireless-enabled device of the wireless communication network; based at least on the first environmental information, generate first enhanced assistance data, the first enhanced assistance data comprising reference information having at least an accuracy that is higher than that of assistance data generated without the environmental information; and send the first enhanced assistance data to the wireless-enabled device, the first enhanced assistance data configured to enable the wireless-enabled device to perform one or more positioning operations using the first enhanced assistance data.
Clause 57. The network apparatus of clause 56, wherein the first environmental information obtained by the wireless-enabled device comprises a type of local environment, audio data, infrared data, object information, radio frequency (RF) data, image data, or a combination thereof.
Clause 58. The network apparatus of clause 56, wherein the network apparatus comprises a location server or a sensing server of the wireless communication network.
Clause 59. The network apparatus of clause 56, wherein the one or more processors are further configured to: send a request for additional environmental information to at least one of a plurality of wireless-enabled devices of the wireless communication network, the plurality of wireless-enabled devices comprising the wireless-enabled device and one or more wireless-enabled devices other than the wireless-enabled device.
Clause 60. The network apparatus of clause 59, wherein the one or more processors are further configured to: receive the additional environmental information; generate, based on the additional environmental information, second enhanced assistance data having an incremental modification over the first enhanced assistance data and having at least an accuracy that is higher than the accuracy of the first enhanced assistance data; and send the second enhanced assistance data to at least the wireless-enabled device.
Clause 61. The network apparatus of clause 56, wherein the generating of the first enhanced assistance data is further based on environmental information obtained using one or more sensors of one or more wireless-enabled devices other than the wireless-enabled device.
Clause 62. The network apparatus of clause 56, wherein the one or more processors are further configured to generate a map or data structure representative of coverage and/or various perceptions of an environment, the map or data structure being generated based at least on the environmental information sensed using the one or more sensors of the one or more wireless-enabled devices other than the wireless-enabled device.
Clause 63. The network apparatus of clause 56, wherein the one or more processors are further configured to: receive second environmental information comprising environmental information obtained by the one or more sensors of the wireless-enabled device, or by one or more sensors of another wireless-enabled device of the wireless communication network; wherein the second environmental information is received at a time different from a time at which the first environmental information is received.
Clause 64. The network apparatus of clause 63, wherein the one or more processors are further configured to: generate second enhanced assistance data different from the first enhanced assistance data based at least on the second environmental information; and send the second enhanced assistance data to the wireless-enabled device, the second enhanced assistance data configured to enable the wireless-enabled device to perform the one or more positioning operations using the second enhanced assistance data.
Clause 65. The network apparatus of clause 56, wherein the one or more processors are further configured to: receive non-environmental information at the network apparatus, the non-environmental information comprising information corresponding to one or more properties of the wireless-enabled device, location information associated with the wireless-enabled device, or a combination thereof.
Clause 66. The network apparatus of clause 65, wherein the information corresponding to the one or more properties of the wireless-enabled device comprises inertia, motion, velocity, acceleration, rotation, pose, or a combination thereof measured by the wireless-enabled device.
Clause 67. The network apparatus of clause 65, wherein the first enhanced assistance data is further based on the non-environmental information.
Clause 68. The network apparatus of clause 65, wherein the one or more positioning operations using the first enhanced assistance data are based on positioning signals associated with one or more satellites to determine a location of the user device.
Clause 69. The network apparatus of clause 56, wherein the one or more positioning operations comprise configuration of a wireless communication channel between the user device and a base station using enhanced beamforming information generated based on the first environmental information sent to the network apparatus.
Clause 70. The network apparatus of clause 56, wherein: the wireless-enabled device comprises a user device; and the receiving of the first environmental information comprises receiving the first environmental information from the user device via LPP (LTE Positioning Protocol).
Clause 71. The network apparatus of clause 56, wherein: the wireless-enabled device comprises a base station; and the receiving of the first environmental information comprises receiving the first environmental information from the base station via NRPPa (NR positioning protocol A).
Clause 72. A method of improving communication in a wireless communication network, the method comprising: obtaining first environmental information using one or more sensors of a wireless-enabled device; sending the first environmental information to a network entity of the wireless communication network; receiving enhanced beamforming information from the network entity, the enhanced beamforming information generated based on the first environmental information sent to the network entity, the enhanced beamforming information comprising one or more characteristics of a plurality of available radio beams between a user device and a first base station of the wireless communication network, wherein the one or more characteristics enabling selection of a radio beam which realizes improved wireless communication between the user device and the first base station; and performing wireless communication using the enhanced beamforming information.
Clause 73. The method of clause 72, wherein the one or more characteristics comprise a direction of a radio beam between the user device and the first base station, a length of a radio beam path, a propagation delay of the radio beam path, an attenuation of the radio beam path, or a combination thereof.
Clause 74. The method of clause 72, wherein the performing of the wireless communication using the enhanced beamforming information comprises selecting the radio beam from the plurality of available radio beams between the user device and the first base station based at least in part on the one or more characteristics of the plurality of available radio beams between the user device and the first base station, the selected radio beam resulting in the improved wireless communication between the user device and the first base station as compared to wireless communication between the user device and the first base station without using the enhanced beamforming information.
Clause 75. The method of clause 72, wherein the wireless-enabled device comprises the first base station, and the improved wireless communication is performed via a communication link associated with the radio beam and between the first base station and the user device.
Clause 76. The method of clause 75, wherein the improved wireless communication between the user device and the first base station is characterized by lower latency, higher bandwidth, higher data transmission rate, higher coverage, higher reliability, higher signal quality, or a combination thereof, of the communication link associated with the radio beam.
Clause 77. The method of clause 75, wherein the enhanced beamforming information comprises an instruction to the wireless-enabled device to, based on the first environmental information, switch to the communication link between the first base station and the user device from another communication link between the user device and a second base station.
Clause 78. The method of clause 72, wherein the wireless-enabled device comprises the user device, and the improved wireless communication is performed via a communication link associated with the radio beam and between the first base station and the user device.
Clause 79. The method of clause 72, wherein the performing the wireless communication using enhanced beamforming information comprises performing a beam selection to provide a connection between the first base station and the user device having a higher signal quality, strength, power, or reliability than a beam selection without the enhanced beamforming information, provide a connection between the first base station and the user device having a higher signal coverage than the beam selection without the enhanced beamforming information, mitigate interference from a physical occlusion in an area associated with the user device, or a combination thereof.
Clause 80. The method of clause 72, wherein the performing of the wireless communication using the enhanced beamforming information comprises adjusting a beamforming configuration of the wireless-enabled device using the enhanced beamforming information.
Clause 81. A user device comprising: one or more transceivers configured to perform data communication in a wireless communication network; one or more memory; one or more processors communicatively coupled to the one or more transceivers and the one or more memory, the one or more processors configured to: obtain first environmental information using one or more sensors of a wireless-enabled device; send the first environmental information to a network entity of the wireless communication network; receive enhanced beamforming information from the network entity, the enhanced beamforming information generated based on the first environmental information sent to the network entity, the enhanced beamforming information comprising one or more characteristics of a plurality of available radio beams between a user device and a first base station of the wireless communication network, wherein the one or more characteristics enabling selection of a radio beam which realizes improved wireless communication between the user device and the first base station; and performing wireless communication using the enhanced beamforming information.
Clause 82. The user device of clause 81, wherein the one or more characteristics comprise a direction of a radio beam between the user device and the first base station, a length of a radio beam path, a propagation delay of the radio beam path, an attenuation of the radio beam path, or a combination thereof.
Clause 83. The user device of clause 81, wherein the performing of the wireless communication using the enhanced beamforming information comprises selecting the radio beam from the plurality of available radio beams between the user device and the first base station based at least in part on the one or more characteristics of the plurality of available radio beams between the user device and the first base station, the selected radio beam resulting in the improved wireless communication between the user device and the first base station as compared to wireless communication between the user device and the first base station without using the enhanced beamforming information.
Clause 84. The user device of clause 81, wherein the wireless-enabled device comprises the first base station, and the improved wireless communication is performed via a communication link associated with the radio beam and between the first base station and the user device.
Clause 85. The user device of clause 84, wherein the enhanced beamforming information comprises an instruction to the wireless-enabled device to, based on the first environmental information, switch to the communication link between the first base station and the user device from another communication link between the user device and a second base station.
Clause 86. The user device of clause 81, wherein the wireless-enabled device comprises the user device, and the improved wireless communication is performed via a communication link associated with the radio beam and between the first base station and the user device.
Clause 87. The user device of clause 81, wherein the performing the wireless communication using enhanced beamforming information comprises performing a beam selection to provide a connection between the first base station and the user device having a higher signal quality, strength, power, or reliability than a beam selection without the enhanced beamforming information, provide a connection between the first base station and the user device having a higher signal coverage than the beam selection without the enhanced beamforming information, mitigate interference from a physical occlusion in an area associated with the user device, or a combination thereof.
Clause 88. A method of improving communication in a wireless communication network, the method comprising: receiving, at a network entity, first sensed environmental information obtained by a wireless-enabled device of the wireless communication network; based at least on the first sensed environmental information, generating enhanced beamforming information having one or more characteristics of a plurality of available radio beams between a user device and at least a first base station of the wireless communication network, wherein the one or more characteristics enable selection of a radio beam which realizes improved wireless communication between the user device and the first base station; and sending the enhanced beamforming information to at least the wireless-enabled device, the enhanced beamforming information configured to enable the wireless-enabled device to perform wireless communication using the enhanced beamforming information.
Clause 89. The method of clause 88, wherein the improved wireless communication using the enhanced beamforming information comprises an adjustment in beamforming configuration of the user device, beamforming configuration of the network entity, or both, to perform wireless communication between the wireless device and the network entity.
Clause 90. The method of clause 88, wherein the improved wireless communication using the enhanced beamforming information comprises a beam selection to provide a connection between the first base station and the user device having a higher signal quality, strength, power, or reliability than a beam selection without the enhanced beamforming information, provide a connection between the first base station and the user device having a higher signal coverage than the beam selection without the enhanced beamforming information, mitigate interference from a physical occlusion in an area associated with the user device, or a combination thereof.
Clause 91. The method of clause 88, wherein the wireless-enabled device comprises the first base station, and the wireless communication is performed via a communication link between the first base station and the user device.
Clause 92. The method of clause 88, wherein the enhanced beamforming information comprises an instruction to the wireless-enabled device to, based on the first sensed environmental information, switch to the communication link between the first base station and the user device from another communication link between the user device and a second base station.
Clause 93. The method of clause 88, wherein the wireless-enabled device comprises the user device, and the wireless communication is performed via a communication link between the first base station and the user device.
Clause 94. A network apparatus comprising: one or more data communication interfaces configured to perform data communication with at least a user device in a wireless communication network; one or more memory; one or more processors communicatively coupled to the one or more data communication interfaces and the one or more memory, the one or more processors configured to: receive, at the network apparatus, first sensed environmental information obtained by a wireless-enabled device of the wireless communication network; based at least on the first sensed environmental information, generate enhanced beamforming information by including one or more characteristics of a plurality of available radio beams between a user device and at least a first base station of the wireless communication network, wherein the one or more characteristics enabling selection of a radio beam which realizes improved wireless communication between the user device and the first base station; and send the enhanced beamforming information to at least the wireless-enabled device, the enhanced beamforming information configured to enable the wireless-enabled device to perform wireless communication using the enhanced beamforming information.
Clause 95. The network apparatus of clause 94, wherein the improved wireless communication using the enhanced beamforming information comprises an adjustment in beamforming configuration of the user device, beamforming configuration of the network apparatus, or both, to perform wireless communication between the wireless device and the network apparatus.
Clause 96. The network apparatus of clause 94, wherein the improved wireless communication using the enhanced beamforming information comprises a beam selection to provide a connection between the first base station and the user device having a higher signal quality, strength, power, or reliability than a beam selection without the enhanced beamforming information, provide a connection between the first base station and the user device having a higher signal coverage than the beam selection without the enhanced beamforming information, mitigate interference from a physical occlusion in an area associated with the user device, or a combination thereof.
Clause 97. The network apparatus of clause 94, wherein the wireless-enabled device comprises the first base station, and the wireless communication is performed via a communication link between the first base station and the user device.
Clause 98. The network apparatus of clause 94, wherein the enhanced beamforming information comprises an instruction to the wireless-enabled device to, based on the first sensed environmental information, switch to the communication link between the first base station and the user device from another communication link between the user device and a second base station.
Clause 99. The network apparatus of clause 45, wherein the wireless-enabled device comprises the user device, and the wireless communication is performed via a communication link between the first base station and the user device.

What is claimed is:

1. A method of performing one or more positioning operations with respect to a user device in a wireless communication network, the method comprising:
obtaining first environmental information using one or more sensors of a wireless-enabled device;
sending the first environmental information to a network entity of the wireless communication network;
receiving first enhanced assistance data from the network entity, the first enhanced assistance data generated based at least on the first environmental information sent to the network entity; and
performing the one or more positioning operations using the first enhanced assistance data received from the network entity, wherein the wireless-enabled device comprises the user device or a base station.

2. The method of claim 1, wherein the first environmental information comprises a type of local environment, audio data, infrared data, object information, radio frequency (RF) data, image data, or a combination thereof.

3. The method of claim 1, further comprising obtaining second environmental information;
wherein:
the second environmental information comprises environmental information sensed by the one or more sensors of the wireless-enabled device, or one or more sensors of another wireless-enabled device of the wireless communication network; and
the second environmental information comprises a type of local environment, audio data, infrared data, object information, radio frequency (RF) data, image data, or a combination thereof.

4. The method of claim 3, further comprising:
sending the second environmental information to the network entity; and
receiving second enhanced assistance data from the network entity, the second enhanced assistance data generated based on the second environmental information, and having an incremental modification over the first enhanced assistance data and having at least an accuracy that is higher than an accuracy of the first enhanced assistance data;
wherein the performing of the one or more positioning operations comprises using the second enhanced assistance data received from the network entity.

5. The method of claim 1, further comprising sending non-environmental information to the network entity, the non-environmental information comprising information corresponding to one or more properties of the wireless-enabled device, location information associated with the wireless-enabled device, or a combination thereof;
wherein the information corresponding to the one or more properties of the wireless-enabled device comprises inertia, motion, velocity, acceleration, rotation, pose, or a combination thereof measured by the wireless-enabled device; and
wherein the first enhanced assistance data is further based on the non-environmental information.

6. The method of claim 1, wherein the first enhanced assistance data is further based on environmental information sensed using one or more sensors of one or more wireless-enabled devices other than the wireless-enabled device.

7. The method of claim 1, wherein:
the network entity comprises a location server or a sensing server of the wireless communication network; and
the generation of the first enhanced assistance data is performed by the location server or the sensing server.

8. The method of claim 1, wherein the one or more positioning operations comprise a positioning method to determine a location of the user device using the first enhanced assistance data;
wherein the positioning method to determine the location of the user device using the first enhanced assistance data comprises a round-trip time (RTT) measurement, a signal strength measurement, an angle of arrival (AoA) measurement, an angle of departure (AoD) measurement, a time of arrival (TOA) measurement, a time difference of arrival (TDOA) measurement, or a combination thereof, the positioning method being with respect to the user device and the base station.

9. The method of claim 1, wherein:
the wireless-enabled device comprises the user device; and
the sending of the first environmental information to the network entity comprises the user device sending the first environmental information to a server via LPP (LTE Positioning Protocol).

10. The method of claim 1, wherein:
the wireless-enabled device comprises the base station; and
the sending of the first environmental information to the network entity comprises the base station sending the first environmental information to a server via NRPPa (NR positioning protocol A).

11. A user device comprising:
one or more transceivers configured to perform data communication in a wireless communication network;
one or more memory;
one or more processors communicatively coupled to the one or more transceivers and the one or more memory, the one or more processors configured to:
obtain first environmental information using one or more sensors of a wireless-enabled device;
send the first environmental information to a network entity of the wireless communication network;
receive first enhanced assistance data from the network entity, the first enhanced assistance data generated based at least on the first environmental information sent to the network entity; and
perform one or more positioning operations using the first enhanced assistance data received from the network entity, wherein the wireless-enabled device comprises the user device or a base station.

12. The user device of claim 11, wherein the first environmental information comprises a type of local environment, audio data, infrared data, object information, radio frequency (RF) data, image data, or a combination thereof.

13. The user device of claim 11, wherein the one or more processors are further configured to obtain second environmental information;
wherein:
the second environmental information comprises environmental information sensed by the one or more sensors of the wireless-enabled device, or one or more sensors of another wireless-enabled device of the wireless communication network; and
the second environmental information comprises a type of local environment, audio data, infrared data, object information, radio frequency (RF) data, image data, or a combination thereof.

14. The user device of claim 13, wherein the one or more processors are further configured to:
send the second environmental information to the network entity; and
receive second enhanced assistance data from the network entity, the second enhanced assistance data generated based on the second environmental information, having an incremental modification over the first enhanced assistance data and having at least an accuracy that is higher than an accuracy of the first enhanced assistance data;
wherein the performing of the one or more positioning operations comprises using the second enhanced assistance data received from the network entity.

15. The user device of claim 11, wherein the one or more processors are further configured to send non-environmental information to the network entity, the non-environmental information comprising information corresponding to one or more properties of the wireless-enabled device, location information associated with the wireless-enabled device, or a combination thereof;
wherein the information corresponding to the one or more properties of the wireless-enabled device comprises inertia, motion, velocity, acceleration, rotation, pose, or a combination thereof measured by the wireless-enabled device; and
wherein the first enhanced assistance data is further based on the non-environmental information.

16. The user device of claim 11, wherein the first enhanced assistance data is further based on environmental information sensed using one or more sensors of one or more wireless-enabled devices other than the wireless-enabled device.

17. The user device of claim 11, wherein:
the network entity comprises a location server or a sensing server of the wireless communication network; and
wherein the generation of the first enhanced assistance data is performed by the location server or the sensing server.

18. The user device of claim 11, wherein the one or more positioning operations comprise a positioning method to determine a location of the user device using the first enhanced assistance data;
wherein the positioning method to determine the location of the user device using the first enhanced assistance data comprises a round-trip time (RTT) measurement between the user device and the base station, signal strength measurement, angle of arrival (AoA), angle of departure (AoD), time of arrival (TOA) measurement, time difference of arrival (TDOA) measurement, or a combination thereof, the positioning method being with respect to the user device and the base station.

19. The user device of claim 11, wherein:
the wireless-enabled device comprises the user device; and
the sending of the first environmental information to the network entity comprises the user device sending the first environmental information to a server via LPP (LTE Positioning Protocol).

20. The user device of claim 11, wherein:
the wireless-enabled device comprises the base station; and
the sending of the first environmental information to the network entity comprises the base station sending the first environmental information to a server via NRPPa (NR positioning protocol A).

21. A network apparatus comprising:
one or more data communication interfaces configured to perform data communication with at least a user device in a wireless communication network;
one or more memory;
one or more processors communicatively coupled to the one or more data communication interfaces and the one or more memory, the one or more processors configured to:
receive, at the network apparatus, first environmental information obtained by a wireless-enabled device of the wireless communication network;
based at least on the first environmental information, generate first enhanced assistance data, the first enhanced assistance data comprising reference information having at least an accuracy that is higher than that of assistance data generated without the environmental information; and
send the first enhanced assistance data to the wireless-enabled device, the first enhanced assistance data configured to enable the wireless-enabled device to perform one or more positioning operations using the first enhanced assistance data.

22. The network apparatus of claim 21, wherein the first environmental information obtained by the wireless-enabled device comprises a type of local environment, audio data, infrared data, object information, radio frequency (RF) data, image data, or a combination thereof.

23. The network apparatus of claim 21, wherein the one or more processors are further configured to send a request for additional environmental information to at least one of a plurality of wireless-enabled devices of the wireless communication network, the plurality of wireless-enabled devices comprising the wireless-enabled device and one or more wireless-enabled devices other than the wireless-enabled device.

24. The network apparatus of claim 21, wherein:
the generation of the first enhanced assistance data is further based on environmental information obtained using one or more sensors of one or more wireless-enabled devices other than the wireless-enabled device;
the one or more processors are further configured to receive second environmental information comprising environmental information obtained by the one or more sensors of the wireless-enabled device, or by one or more sensors of another wireless-enabled device of the wireless communication network;
the second environmental information is received at a time different from a time at which the first environmental information is received.

25. The network apparatus of claim 24, wherein the one or more processors are further configured to:
generate second enhanced assistance data different from the first enhanced assistance data based at least on the second environmental information; and
send the second enhanced assistance data to the wireless-enabled device, the second enhanced assistance data configured to enable the wireless-enabled device to perform the one or more positioning operations using the second enhanced assistance data.

26. The network apparatus of claim 21, wherein the one or more processors are further configured to generate a map or data structure representative of coverage and/or various perceptions of an environment, the map or data structure being generated based at least on the environmental information sensed using one or more sensors of the one or more wireless-enabled devices other than the wireless-enabled device.

27. The network apparatus of claim 21, wherein the one or more processors are further configured to receive non-environmental information at the network apparatus, the non-environmental information comprising information corresponding to one or more properties of the wireless-enabled device, location information associated with the wireless-enabled device, or a combination thereof;
wherein the first enhanced assistance data is further based on the non-environmental information.

28. The network apparatus of claim 21, wherein the one or more positioning operations comprise configuration of a wireless communication channel between the user device and a base station using enhanced beamforming information generated based on the first environmental information sent to the network apparatus.

29. The network apparatus of claim 21, wherein:
the wireless-enabled device comprises a user device; and
the receiving of the first environmental information comprises receiving the first environmental information from the user device via LPP (LTE Positioning Protocol).

30. The network apparatus of claim 21, wherein:
the wireless-enabled device comprises a base station; and
the receiving of the first environmental information comprises receiving the first environmental information from the base station via NRPPa (NR positioning protocol A).

31. A method of improving communication in a wireless communication network, the method comprising:
obtaining first environmental information using one or more sensors of a wireless-enabled device;
sending the first environmental information to a network entity of the wireless communication network;
receiving enhanced beamforming information from the network entity, the enhanced beamforming information generated based on the first environmental information sent to the network entity, the enhanced beamforming information comprising one or more characteristics of a plurality of available radio beams between a user device and a first base station of the wireless communication network, wherein the one or more characteristics enabling selection of a radio beam which realizes improved wireless communication between the user device and the first base station; and
performing wireless communication using the enhanced beamforming information.

32. The method of claim 31, wherein the one or more characteristics comprise a direction of a radio beam between the user device and the first base station, a length of a radio beam path, a propagation delay of the radio beam path, an attenuation of the radio beam path, or a combination thereof.

33. The method of claim 31, wherein the performing of the wireless communication using the enhanced beamforming information comprises selecting the radio beam from the plurality of available radio beams between the user device and the first base station based at least in part on the one or more characteristics of the plurality of available radio beams between the user device and the first base station, the selected radio beam resulting in the improved wireless communication between the user device and the first base station as compared to wireless communication between the user device and the first base station without using the enhanced beamforming information.

34. The method of claim 31, wherein the wireless-enabled device comprises the first base station, and the improved wireless communication is performed via a communication link associated with the radio beam and between the first base station and the user device.

35. The method of claim 34, wherein the enhanced beamforming information comprises an instruction to the wireless-enabled device to, based on the first environmental information, switch to the communication link between the first base station and the user device from another communication link between the user device and a second base station.

36. The method of claim 31, wherein the wireless-enabled device comprises the user device, and the improved wireless communication is performed via a communication link associated with the radio beam and between the first base station and the user device.

37. The method of claim 31, wherein the performing the wireless communication using enhanced beamforming information comprises performing a beam selection to provide a connection between the first base station and the user device having a higher signal quality, strength, power, or reliability than a beam selection without the enhanced beamforming information, provide a connection between the first base station and the user device having a higher signal coverage than the beam selection without the enhanced beamforming information, mitigate interference from a physical occlusion in an area associated with the user device, or a combination thereof.

38. A user device comprising:
one or more transceivers configured to perform data communication in a wireless communication network;
one or more memory;
one or more processors communicatively coupled to the one or more transceivers and the one or more memory, the one or more processors configured to:
obtain first environmental information using one or more sensors of a wireless-enabled device;
send the first environmental information to a network entity of the wireless communication network;
receive enhanced beamforming information from the network entity, the enhanced beamforming information generated based on the first environmental information sent to the network entity, the enhanced beamforming information comprising one or more characteristics of a plurality of available radio beams between a user device and a first base station of the wireless communication network, wherein the one or more characteristics enabling selection of a radio beam which realizes improved wireless communication between the user device and the first base station; and
perform wireless communication using the enhanced beamforming information.

39. The user device of claim 38, wherein the one or more characteristics comprise a direction of a radio beam between the user device and the first base station, a length of a radio beam path, a propagation delay of the radio beam path, an attenuation of the radio beam path, or a combination thereof.

40. The user device of claim 38, wherein the performing of the wireless communication using the enhanced beamforming information comprises selecting the radio beam from the plurality of available radio beams between the user device and the first base station based at least in part on the one or more characteristics of the plurality of available radio beams between the user device and the first base station, the selected radio beam resulting in the improved wireless communication between the user device and the first base station as compared to wireless communication between the user device and the first base station without using the enhanced beamforming information.

41. The user device of claim 38, wherein the wireless-enabled device comprises the first base station, and the improved wireless communication is performed via a communication link associated with the radio beam and between the first base station and the user device.

42. The user device of claim 41, wherein the enhanced beamforming information comprises an instruction to the wireless-enabled device to, based on the first environmental information, switch to the communication link between the first base station and the user device from another communication link between the user device and a second base station.

43. The user device of claim 38, wherein the wireless-enabled device comprises the user device, and the improved wireless communication is performed via a communication link associated with the radio beam and between the first base station and the user device.

44. The user device of claim 38, wherein the performing the wireless communication using enhanced beamforming information comprises performing a beam selection to provide a connection between the first base station and the user device having a higher signal quality, strength, power, or reliability than a beam selection without the enhanced beamforming information, provide a connection between the first base station and the user device having a higher signal coverage than the beam selection without the enhanced beamforming information, mitigate interference from a physical occlusion in an area associated with the user device, or a combination thereof.

45. A network apparatus comprising:
one or more data communication interfaces configured to perform data communication with at least a user device in a wireless communication network;
one or more memory;
one or more processors communicatively coupled to the one or more data communication interfaces and the one or more memory, the one or more processors configured to:
receive, at the network apparatus, first sensed environmental information obtained by a wireless-enabled device of the wireless communication network;
based at least on the first sensed environmental information, generate enhanced beamforming information by including one or more characteristics of a plurality of available radio beams between a user device and at least a first base station of the wireless communication network, wherein the one or more characteristics enabling selection of a radio beam which realizes improved wireless communication between the user device and the first base station; and
send the enhanced beamforming information to at least the wireless-enabled device, the enhanced beamforming information configured to enable the wireless-enabled device to perform wireless communication using the enhanced beamforming information.

46. The network apparatus of claim 45, wherein the improved wireless communication using the enhanced beamforming information comprises an adjustment in beamforming configuration of the user device, beamforming configuration of the network apparatus, or both, to perform wireless communication between the wireless device and the network apparatus.

47. The network apparatus of claim 45, wherein the improved wireless communication using the enhanced beamforming information comprises a beam selection to provide a connection between the first base station and the user device having a higher signal quality, strength, power, or reliability than a beam selection without the enhanced beamforming information, provide a connection between the first base station and the user device having a higher signal coverage than the beam selection without the enhanced beamforming information, mitigate interference from a physical occlusion in an area associated with the user device, or a combination thereof.

48. The network apparatus of claim 45, wherein the wireless-enabled device comprises the first base station, and the wireless communication is performed via a communication link between the first base station and the user device.

49. The network apparatus of claim 45, wherein the enhanced beamforming information comprises an instruction to the wireless-enabled device to, based on the first sensed environmental information, switch to the communication link between the first base station and the user device from another communication link between the user device and a second base station.

50. The network apparatus of claim 45, wherein the wireless-enabled device comprises the user device, and the wireless communication is performed via a communication link between the first base station and the user device.
